(19) United States
(12) Patent Application Publication
(10) Pub. No.: US 2018/0232799 A1
(43) Pub. Date: Aug. 16, 2018

(54) EXHIBITION DEVICE, DISPLAY CONTROL DEVICE AND EXHIBITION SYSTEM

(71) Applicant: NEC Corporation, Tokyo (JP)

(72) Inventors: Takeharu KITAGAWA, Tokyo (JP); Nobuyuki YAMASHITA, Tokyo (JP)

(73) Assignee: NEC Corporation, Minato-ku, Tokyo (JP)

(21) Appl. No.: 15/751,237

(22) PCT Filed: Aug. 19, 2016
(86) PCT No.: PCT/JP2016/074172

§ 371 Date: Feb. 8, 2018

(30) Foreign Application Priority Data
Aug. 20, 2015 (JP) 2015-162640

(51) Int. Cl. G06Q 30/06; G06Q 30/02

(52) U.S. Cl. CPC G06Q 30/0643; G06Q 30/0255; G06Q 30/0623

(57) ABSTRACT

Provided is an exhibition device that is installed in a store, for example, and controls the display mode of a product image so as to call the attention of a user to a product and also arouse the interest of the user. The exhibition device is provided with an exhibition region in which an object (such as a product) is exhibited and a display region of an image corresponding to the object, and changes the display mode of the display region on the basis of object information relating to the object and/or moving body information relating to a moving body (such as a user). In addition, an exhibition system is composed of the exhibition device and an information processing device that estimates whether the moving body is interested in the object exhibited in the exhibition region. Due to this configuration, the exhibition device is able to change the display mode of the display region corresponding to an image of an object in which a moving body is estimated to be interested.

### TECHNICAL FIELD

The present invention relates to an exhibition apparatus that displays a real object such as a product and displays an image related to the real object, a display control apparatus that controls a display image thereof, and an exhibition system that includes the exhibition apparatus and an information processing device.

This application claims priority right based on JP 2015-162640 filed in Japan on Aug. 20, 2015, the content of which is incorporated herein by reference.

### BACKGROUND ART

In recent years, instead of a sales form in which a real object such as a product is displayed on a shelf to be presented to a purchaser, a sales form is adopted in a marketing site in which an image of a real object such as a product is displayed on a display device to be exhibited to a purchaser. Such sales form is called a virtual store. A seller who sells a product in a virtual store, for example, displays a product image and a QR code® associated with the product on a display provided in a vending machine. A user (purchaser) reads the QR code® of the favorite product with a smartphone or the like and purchases the product. Using the virtual store, the seller can exhibit a large number of products in a limited space. On the other hand, users have the advantage of being able to easily purchase products.

Various technologies have been developed for exhibition, display and advertisement of products. PTL 1 discloses a product selection support device that changes a display form of an image of a product based on the result of the gaze of user (purchaser) on the image of the product displayed on the display of the vending machine. For example, the product selection support device detects the gaze of the user on the image of the product, and calculates its attention degree. The product selection support device provides a display image suitable for the user by emphasizing and displaying the image of the product for which the user has a high attention degree.

PTL 2 discloses a video display device which detects a video in which a plurality of video viewers are interested on a display screen having a main area and a sub-area and switches the video from the sub-area to the main area. PTL 3 discloses an advertisement providing device that provides the customer with useful information about a product exhibited in shelf. PTL 4 discloses a product exhibition shelf which can be remodeled in various types and can enhance the production effect of the exhibition of the product.

### CITATION LIST

### Patent Literature

PTL 1: JP 2012-22589 A
PTL 2: JP 2006-119408 A
PTL 3: JP 2001-134225 A
PTL 4: Publication of Utility Model Registration No. 3182957

### SUMMARY OF INVENTION

### Technical Problem

PTL 1 technology cannot effectively utilize the display area which displays images such as products. For example, in a general virtual store, a state in which the image of the products are fixedly exhibited on the display is displayed, and the exhibition volume of the products, which are desired to be shown according to the attribute information about the user (purchaser) and the individual user, cannot be changed. In PTL 2, it is necessary to calculate the display desire degree representing that the viewer wants the display of a specific video and replace the video between the main area and the sub-area in such a way that the video with the highest display desire degree is displayed in the main area. However, it is impossible to estimate the product in which the user (purchaser) is interested and change its display mode.

The present invention has been made in view of the above problems, and it is an object of the present invention to provide an exhibition apparatus, a display control apparatus, and an exhibition system that can dynamically change display mode of a real object such as a product.

### Solution to Problem

A first aspect of the present invention is an exhibition apparatus that includes: an exhibition area exhibiting a real object; a display area corresponding to the real object; and a control unit changing a display mode of the display area based on at least one of real object information about the real object and moving object information about a moving object.

A second aspect of the present invention is a display control apparatus to be applied to an exhibition apparatus including an exhibition area exhibiting a real object, and a display area corresponding to the real object. The display control apparatus includes a control unit changing a display mode of the display area based on at least one of real object information about the real object and moving object information about a moving object.

A third aspect of the present invention is an exhibition system that includes: an exhibition apparatus including an exhibition area exhibiting a real object, and a display area corresponding to the real object; and a display control apparatus changing a display mode of the display area based on at least one of real object information about the real object and moving object information about a moving object.

A fourth aspect of the present invention is an exhibition system. The exhibition system includes an exhibition apparatus and an information processing device. The exhibition apparatus includes an exhibition area exhibiting a real object, a display area corresponding to the real object, and a control unit changing a display mode of the display area based on at least one of real object information about the real object and moving object information about a moving object. The information processing device includes an interest estimation unit estimating whether the moving object is interested in the real object exhibited in the exhibition area, and the control unit changes a display mode of the display area corresponding to an image of the real object which the interest estimation unit estimates that the moving object is interested in.

A fifth aspect of the present invention is a display control method to be applied to an exhibition apparatus including an exhibition area and a display area. The method includes displaying, in the display area, an image corresponding to a real object exhibited in the exhibition area; and changing a display mode of the display area based on at least one of real object information about the real object and moving object information about a moving object.

A sixth aspect of the present invention is a program executed by a computer of an exhibition apparatus including an exhibition area and a display area. The computer executes the program to cause displaying, in the display area, an image corresponding to a real object exhibited in the exhibition area; and changing a display mode of the display area based on at least one of real object information about the real object and moving object information about a moving object.

### Advantageous Effects of Invention

According to the present invention, when exhibiting a product in a store and the like and displaying a product image or product information on a display, it is possible to draw attention of the user and attract the user's interest. For example, you can change the display mode of the display area corresponding to the product image when the user approaches the exhibition apparatus, or when the user picks up the product exhibited in the exhibition apparatus.

### BRIEF DESCRIPTION OF DRAWINGS

FIG. 1 is a block diagram showing a minimum configuration of an exhibition apparatus according to a first embodiment of the present invention.

FIG. 2 is a flowchart showing processing procedure of the exhibition apparatus according to the first embodiment of the present invention.

FIG. 3 is a block diagram showing an exhibition system according to the first embodiment of the present invention.

FIG. 4 is a layout showing one example of a floor of a store to which the exhibition system according to the first embodiment is applied.

FIG. 5 is an image diagram showing a first example of a product exhibition image displayed by the exhibition apparatus according to the first embodiment.

FIG. 6 is a flowchart showing a first example of change control processing of the display area of the exhibition apparatus according to the first embodiment.

FIG. 7 is a flowchart showing a second example of change control processing of the display area of the exhibition apparatus according to the first embodiment.

FIG. 8 is a flowchart showing a third example of change control processing of the display area of the exhibition apparatus according to the first embodiment.

FIG. 9A is an image diagram showing a second example of a product exhibition image displayed by the exhibition apparatus according to the first embodiment.

FIG. 9B is an image diagram showing a third example of a product exhibition image displayed by the exhibition apparatus according to the first embodiment.

FIG. 9C is an image diagram showing a fourth example of a product exhibition image displayed by the exhibition apparatus according to the first embodiment.

FIG. 9D is an image diagram showing a fifth example of a product exhibition image displayed by the exhibition apparatus according to the first embodiment.

FIG. 10 is an image diagram showing a sixth example of a product exhibition image displayed by the exhibition apparatus according to the first embodiment.

FIG. 11 is a block diagram showing an exhibition system according to a second embodiment of the present invention.

FIG. 12 is a layout showing one example of a floor of a store to which the exhibition system according to the second embodiment is applied.

FIG. 13 is an image diagram showing a seventh example of a product exhibition image displayed by the exhibition apparatus according to the second embodiment.

FIG. 14 is a flowchart showing change control processing of a display area of the exhibition apparatus according to the second embodiment.

FIG. 15 is a block diagram showing an exhibition system according to a third embodiment of the present invention.

FIG. 16 is a flowchart showing change control processing of the display area of the exhibition apparatus according to the third embodiment.

FIG. 17 is a block diagram showing an exhibition system according to a fourth embodiment of the present invention.

FIG. 18 is a flowchart showing change control processing of the display area of the exhibition apparatus according to the fourth embodiment.

FIG. 19 is a block diagram showing an exhibition system according to a fifth embodiment of the present invention.

FIG. 20 is a flowchart showing change control processing of the display area of the exhibition apparatus according to the fifth embodiment.

FIG. 21 is a network diagram showing a first network configuration applied to the exhibition system according to the present invention.

FIG. 22 is a network diagram showing a second network configuration applied to the exhibition system according to the present invention.

FIG. 23 is a block diagram showing a minimum configuration of the exhibition system according to the present invention.

FIG. 24 is a block diagram showing a minimum configuration of a control device included in the exhibition system according to the present invention.

### DESCRIPTION OF EMBODIMENTS

An exhibition apparatus, a display control apparatus, and an exhibition system according to the present invention will be explained with embodiments with reference to the attached drawings.

### First Embodiment

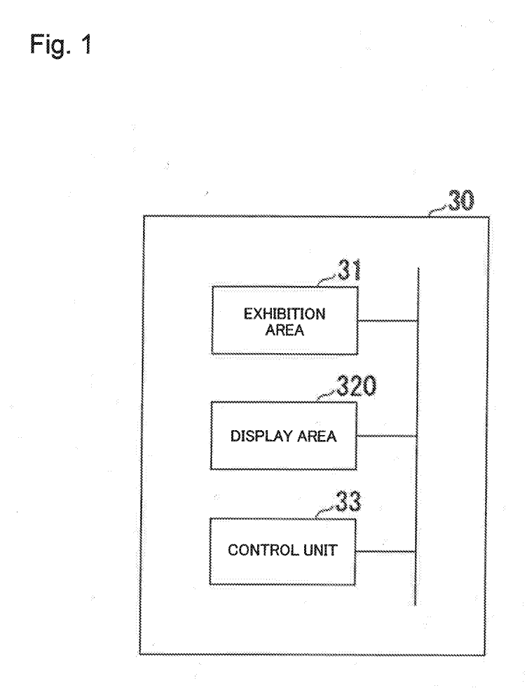

An exhibition apparatus 30 according to the first embodiment of the present invention will be described with reference to FIGS. 1 to 10. FIG. 1 is a block diagram showing the minimum configuration of the exhibition apparatus 30 according to the first embodiment. The exhibition apparatus 30 includes at least an exhibition area 31, a display area 320, and a control unit 33. The exhibition area 31 is an area for exhibiting real objects such as products. The exhibition area 31 is, for example, a shelf exhibiting the products, or a stand and a net hanging and showing the products. The display area 320 displays an image on an output unit such as, for example, a display, in association with the real object exhibited in the exhibition area 31. The control unit 33 controls the display mode of the display area 320. In particular, the control unit 33 changes the display mode of the display area 320 based on at least one of information (hereinafter referred to as real object information) about real object and information (hereinafter referred to as moving body information) about a moving object (for example, a person, and the like).

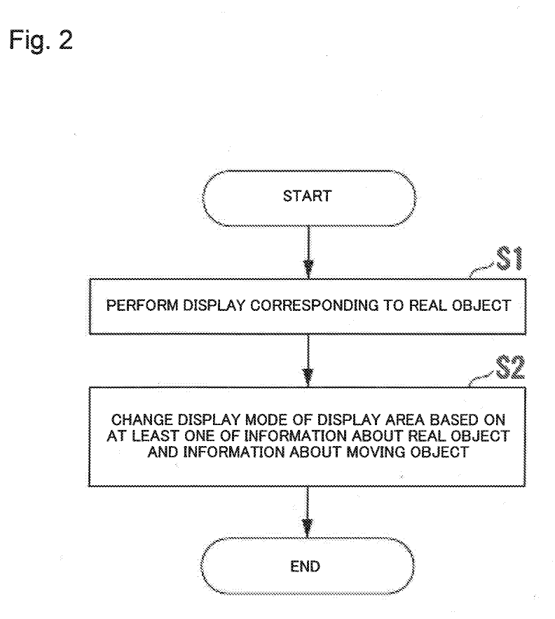

FIG. 2 is a flowchart showing processing procedure of the exhibition apparatus 30. With reference to FIG. 2, the display mode change processing of the display area 320 with the minimum configuration of the exhibition apparatus 30 will be described.

First, the control unit 33 causes a display corresponding to the real object (step S1). The real object is an article to be exhibited in the exhibition area 31 such as, for example, product or exhibit. The real objects other than the article may be, for example, posters and signs. Causing “display corresponding to real object” is to display an image on a display in which one or more products exhibited in, for example, the exhibition area 31 are arranged. Alternatively, it may be possible to display information about the product (product description, product introduction, commercial, and the like). The control unit 33 obtains the image data corresponding to the real object and outputs the image data to the display or a similar device of the display.

Next, the control unit 33 changes the display mode of the display area 320 based on at least one of the real object information and the moving object information (step S2). For example, the real object information is an attribute such as type, size, shape, smell of a product exhibited in the exhibition area 31. The moving object information is, for example, an attribute such as the age and sex of a person viewing the display area 320, a facial image, movement of the person, the distance between the person and the exhibition apparatus 30, and the like. The moving object is a person related to a real object, a person detected by a sensor in relation to a real object, and the like. The moving object is not limited to a person. In addition to a person, the moving object may be a robot, an animal, an unmanned aerial vehicle, or the like. The control unit 33 changes the display mode of the display area 320 based on at least one of the real object information and the moving object information. Here, the “change the display mode” means, for example, enlarging the display area 320. Alternatively, it is also possible to change the color to be displayed on the display area 320, to change the brightness, or to enlarge or reduce an image such as the display product. Still alternatively, changes in the color, the brightness, and the size of the image may be combined appropriately.

For example, in case of changing the display mode of the display area 320 based on the real object information, the control unit 33 enlarges and displays the product image in the display area 320 corresponding to the product image on the display based on the exhibition of the small product in the exhibition area 31. When changing the display mode of the display area 320 based on the moving object information, the control unit 33 enlarges the display area 320 corresponding to the product image when it is estimated that the person viewing the display area 320 is interested in the product exhibited in the exhibition area 31. The control unit 33 includes a function for performing control to change the display mode of the display area 320 based on the real object information or the moving object information, and a function for outputting the image generated based on the real object information or moving object information. As described later in the fourth embodiment, for example, the control unit 33 may have a function to determine whether to change the display area 320 such as enlarging and displaying the product image in the display area 320 corresponding to the product image based on the exhibition of the small product in the exhibition area 31.

In the above description, the display mode change processing has been described based on the assumption that the exhibition apparatus 30 has the control unit 33 in accordance with the minimum configuration shown in FIG. 1. However, the exhibition apparatus 30 does not necessarily have the control unit 33. In that case, the edge terminal device 204, which will be described later, has a function (function of an output control unit 263 to be described later) corresponding to the control unit 33, and the output control unit 263 may control the change of the display mode of the display area 320.

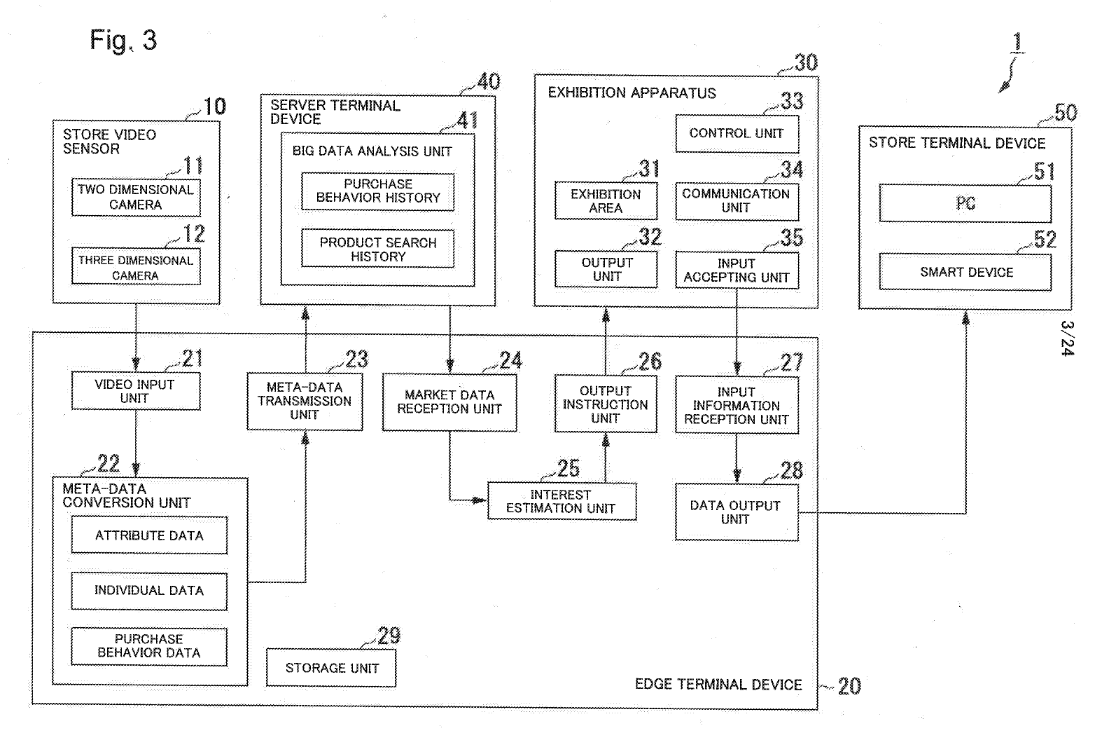

FIG. 3 is a block diagram illustrating an exhibition system 1 according to the first embodiment of the present invention. The exhibition system 1 directs the attention of visitors (users) to the product exhibited on exhibition apparatus 30, shelf, and the like. The exhibition system 1 is composed of a store video sensor 10, an edge terminal device 20, an exhibition apparatus 30, a server terminal device 40, and a store terminal device 50. The store video sensor 10 is an image sensor photographing a state around the exhibition apparatus 30 in the store and a state of the user who selects the product in front of the exhibition apparatus 30. The state near the exhibition apparatus 30 is, for example, photographed with a two-dimensional camera. The state of the user who selects the product is photographed using a three-dimensional camera.

The edge terminal device 20 is an information processing device installed in the store utilizing the exhibition apparatus 30. The edge terminal device 20 generates a product exhibition image to be displayed on the exhibition apparatus 30 based on the image detected by the store video sensor 10 and the information analyzed by the server terminal device 40. Here, the product exhibition image includes the entire area of the image displayed by the output unit 32. The edge terminal device 20 includes a video input unit 21, a meta-data conversion unit 22, a meta-data transmission unit 23, a market data reception unit 24, an interest estimation unit 25, an output instruction unit 26, an input information reception unit 27, a data output unit 28, and a storage unit 29.

The edge terminal device 20 is a personal computer (PC) having a small box-shaped casing, and can be equipped with additional modules (for example, an image processing module, an analysis module, a target specification module, an estimation module, and the like) having various functions. The functions of the meta-data conversion unit 22 and the interest estimation unit 25 are realized by an added module. The edge terminal device 20 can communicate with other devices using various communication means. Various communication means include, for example, wired communication via a LAN (Local Area Network) cable or optical fiber, wireless communication based on communication method such as Wi-Fi (Wireless Fidelity), communication using a carrier network with SIM (Subscriber Identity Module) card equipped therein, and the like. When transmitting images obtained by photographing a situation of a store and the like and the information detected by sensors and the like to a server terminal device installed in the data center and the like, there is a possibility that, e.g., the network is overloaded or information is leaked. Therefore, usually, the edge terminal device 20 is installed on the store side provided with cameras and sensors, so that image processing and analysis are performed on the images, whereby the images are converted into meta-data, and the meta-data is transmitted to the server terminal device.

The video input unit 21 inputs the image photographed by the store video sensor 10. The store video sensor 10 is provided with two dimensional camera 11 and three dimensional camera 12. The meta-data conversion unit 22 converts the image input by the video input unit 21 into meta-data. For example, the meta-data conversion unit 22 analyzes the image captured by the two dimensional camera 11 and sends the attribute data of the person included in the image to the meta-data transmission unit 23. The attribute data is, for example, the age and sex of a person. In addition, the meta-data conversion unit 22 analyzes the image captured by the two dimensional camera 11 and specifies the person included in the image. In the storage unit 29, the facial image and the like of the user frequently visiting the store are registered in advance, and the image input by the video input unit 21 is collated with the facial image registered in advance, so that the user appearing in the input image is specified. The meta-data conversion unit 22 sends the individual data (for example, user ID, and the like) of the specified user to the meta-data transmission unit 23. The meta-data conversion unit 22 converts the image photographed by the three dimensional camera 12 into purchase behavior data. The three dimensional camera 12 is attached to a position where it is possible to photograph an action of the user in front of the shelf from the ceiling side of the store (hereinafter referred to as shelf front action). From the three dimensional image captured by the three dimensional camera 12, the distance between the three dimensional camera 12 and the subject can be obtained. For example, if the three dimensional image contains an image in which the user obtains a product on a shelf, it is possible to measure the distance between three dimensional camera 12 and the position where the user reaches out in order to obtain the product, and it is possible to determine from which stage of the product shelf the user obtained the product from. The meta-data conversion unit 22 specifies the product on the shelf that the user reaches out from the three dimensional image and the number of the products, and sends specified data to the meta-data transmission unit 23 as purchasing behavior data.

The meta-data transmission unit 23 transmits the meta-data sent from the meta-data conversion unit 22 to the server terminal device 40. The market data reception unit 24 receives market data from the server terminal device 40. The market data is information indicating the tendency of purchase behavior corresponding to attribute information about the user. The market data is the purchase behavior history of the product about the individual user, and the like. Based on the market data received by the market data reception unit 24, the interest estimation unit 25 estimates the product that the user class indicated by the attribute information is interested in. The interest estimation unit 25 estimates the product that the individual user specified by the meta-data conversion unit 23 is interested in.

The output instruction unit 26 transmits instruction information to the exhibition apparatus 30 so as to perform volume-display of the product estimated by the interest estimation unit 25. The volume-display is to enlarge and display the display area corresponding to the product exhibited on the shelf. For example, when the output unit 32 of the exhibition apparatus 30 is constituted by a plurality of displays, the display area corresponding to one product corresponds to one display in a normal display mode. When the display mode is volume-display, the display area corresponding to the volume-displayed product may be enlarged to a plurality of displays. The input information reception unit 27 receives information including the selection operation of the user for the product exhibited in the exhibition apparatus 30, and accepts the selection operation of the user. The data output unit 28 transmits the information of the product selected by the user accepted by the input information reception unit 27 to the store terminal device 50. The storage unit 29 stores various kinds of information such as the user's facial image, the image of product, and the like.

The exhibition apparatus 30 includes an exhibition area 31 for exhibiting the product and an output unit 32 for displaying the image of the product. Multiple exhibition areas 31 may be provided for one exhibition apparatus 30. The output unit 32 has a display area 320 corresponding to the image of the product exhibiting in the exhibition area 31. For example, the output unit 32 is a display capable of three dimensional display. Alternatively, it may be a projector that projects an image on the wall surface on which the exhibition apparatus 30 is installed. In the case where multiple exhibition areas 31 are provided in the exhibition apparatus 30, the output unit 32 displays an image including display areas corresponding to the each product exhibited in different exhibition areas 31. For example, when four kinds of products are exhibited in the exhibition area 31, four display areas are displayed corresponding to the each product. The output unit 32 is not limited to an image display device. The output unit 32 may include a device for emitting an odor related to a product exhibited in the exhibition area 31, or an ultrasonic haptics that provide the user with haptic information such as hardness or softness of the product and a haptic experience such as operation feeling that the user feels when the user operates the product.

In the exhibition apparatus 30, the control unit 33 displays the product exhibition image received from the output instruction unit 26 to the output unit 32. When it is assumed that, for example, products A, B, C, and D are exhibited in the exhibition area 31, and when the product exhibition image in which the product A is volume-displayed is received from the output instruction unit 26, the control unit 33 controls to display the product exhibition image on the output unit 32. In this case, for example, the product exhibition image is a display obtained by enlarging the display area corresponding to the product A and displaying a larger number of products A than the products A displayed in the display area before the enlarged display area is enlarged. This makes the products A volume-displayed on the output unit 32 easier to be seen from the user, so that the user's attention is attracted to the product A. As will be described later, the volume-display is realized in various modes.

The exhibition apparatus 30 further includes a communication unit 34 and an input accepting unit 35. The communication unit 34 communicates with other devices such as the edge terminal device 20. The input accepting unit 35 receives the selection operation of the product from the user. For example, the output unit 32 is a display in which a touch panel and a liquid crystal display unit are combined in an integrated manner, and a product selection button is displayed on an output unit 32. In this case, the input accepting unit 35 accepts the operation of the button selected by the user. Alternatively, the input operation unit 35 may acquire information about the product selected by the user operating the smartphone via the network such as a carrier network, and accept the selection information about the product. The input accepting unit 35 transmits the selection information about the product to the edge terminal device 20.

The server terminal device 40 is installed in, for example, a data center. The server terminal device 40 accumulates information such as purchase history about products by many consumers. The server terminal device 40 also has a big data analysis unit 41. The big data analysis unit 41 performs marketing analysis such as accumulating information such as images received from the edge terminal device 20, products purchased by the user, products searched for by the user, and the like, and identifying the product selling well for each age group and sex.

The store terminal device 50 runs, for example, an inventory management system, a product ordering system, a POS system, and the like. The store terminal device 50 is a smart device 52 such as, for example, a personal computer (PC) 51 or a tablet terminal. When the store terminal device 50 receives information about the product selected by the user from the data output unit 28 of the edge terminal device 40, the store terminal device 50 generating information for instructing the store clerk to move a predetermined number of products from the inventory of the products to the shelf and displays the products on the display provided in the store terminal device 50. It should be noted that a plurality of exhibition apparatuses 30 may be connected to one edge terminal device 20.

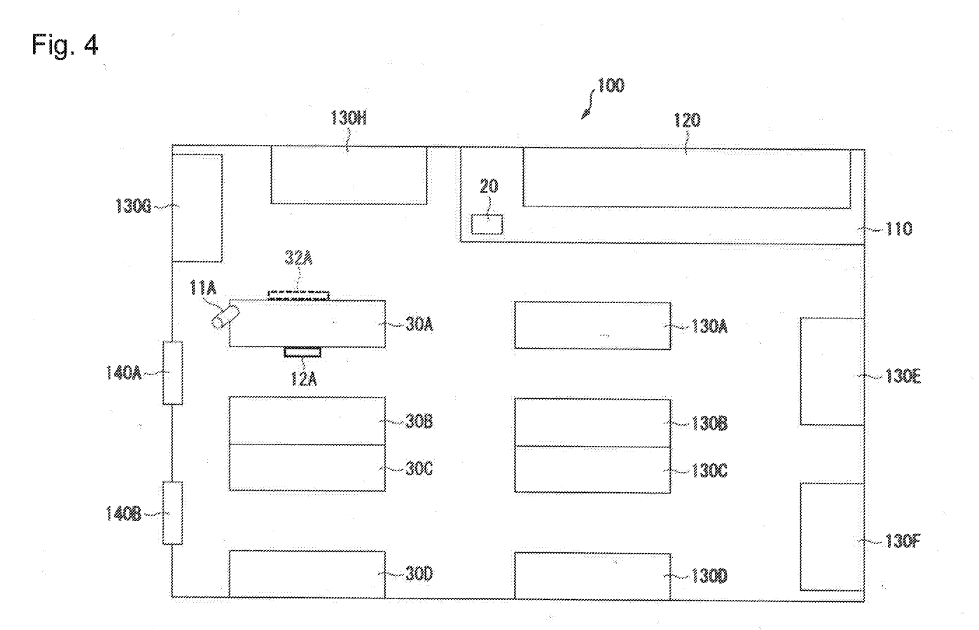

FIG. 4 is a layout showing one example of a floor 100 of the store applying exhibition system 1. The floor 100 is equipped with an edge terminal device 20, four exhibition apparatuses 30A to 30D, a cash register 110, cash register shelf 120, and eight shelfs 130A to 130H. For example, floor 100 is the department of a drugstore. The exhibition apparatuses 30A to 30D are installed close to the entrances 140A and 140B of the floor 100. In the exhibition apparatus 30A, a two dimensional camera 11A and a three dimensional camera 12A are mounted. The two dimensional camera 11A photographs the user approaching the exhibition apparatus 30A. For example, the three dimensional camera 12A is mounted from the highest position of the exhibition apparatus 30A toward the ground side, and photographs, from above, an operation in which the user reaches out for the product exhibited in the exhibition area 31. In addition, the exhibition apparatus 30A has a display 32A which is an example of the output unit 32. The other exhibition apparatuses 30B to 30D are similar to the exhibition apparatus 30A. It should be noted that the exhibition apparatuses 30A to 30D are collectively referred to as exhibition apparatuses 30. In addition, the shelfs 130A to 130H are collectively referred to as shelfs 130. The shelfs 130A to 130H are installed at the far side from the center of the floor 100. In the floor 100, the products such as medicine, cosmetics, daily necessities, and the like are classified according to, for example, the purpose of the product and are exhibited on the shelfs 130A to 130H. On the cash register shelf 120, medicines and the like that require pharmacist's explanation at the time of purchase are displayed.

On the other hand, meanwhile, regardless of the use of product and the like, for example, new products or well-selling products, or products for which the general consumer's awareness is low but the sales can be expected to increase in the future, and the like are exhibited in the exhibition apparatuses 30A to 30D. On the display 32A, a product exhibition image showing a state in which those products are exhibited is displayed.

Next, a product exhibition image displayed on the display 32A of the exhibition apparatus 30A will be described. The exhibition apparatus 30A can exhibit one or more types of products. The product exhibition image displayed on the display 32A is provided for each of the products exhibited in the display area displaying the image of the product. In each display area, an image showing how the product is being exhibited side by side is displayed. In other words, instead of exhibiting the actual product, how the product is exhibited can be expressed by displaying the exhibition image of the product. In the method of displaying images in which products are arranged instead of exhibiting actual products, it is possible to display a large number of types of products with images, so that it is possible to save the product exhibition space and save labors of the actual product exhibition work. In addition, the exhibition apparatus 30 according to the present embodiment can increase the attention and interest in the products by the user by changing the display mode of the display area of product. In the present embodiment, the exhibition apparatus 30 is installed in the vicinity of the entrances 140A, 140B of the floor 100 through which the user passes before he or she searches the shelf 130 for the desired product, and the display mode of the display area of the product is controlled, so that it is possible to improve awareness and purchase motivation for products other than the product which the user is looking for.

The exhibition apparatus 30 controls the display mode of the display area of the product based on the past purchase behavior history in each time zone, which records the age and gender of the user who comes to the store and what kind of product the user purchased. For example, the exhibition apparatus 30 enlarges and displays (volume-display) the display area of the products which is most likely to be purchased by the user class who is likely to visit the store during the specified time zone. The exhibition apparatus 30 displays numerous images of that product in the enlarged display area than the product displayed in the display area before enlargement. By doing so, it can be expected to increase purchase motivation, interest, awareness of the product by the user class who is most likely to visit the store in the specification time zone. Furthermore, the exhibition apparatus 30 may enlarge and display the display area of the product that is most likely to be purchased by the user who comes to the store under the specific environment according to the season, the day of week, the weather, or the like.

According to the past purchase behavior history of the user included in the image photographed by the store video sensor 10, the exhibition apparatus 30 enlarges and displays (volume-display) the display area of the product, specified by the meta-data conversion unit 22, that the user is most likely purchase. Furthermore, the exhibition apparatus 30 displays a larger number of images of products in the enlarged display area than the product displayed in the display area before enlargement. As a result, it is expected to increase purchase motivation for products frequently purchased by the users (such as regular customers).

Next, an outline of the processing of the exhibition system 1 required to control the display area of the exhibition apparatus 30 will be described. First, the two dimensional camera 11A and the three dimensional camera 12A transmit the captured video to the edge terminal device 20. In the edge terminal device 20, the video input unit 21 receives the video and sends the video to the meta-data conversion unit 22. The meta-data conversion unit 22 extracts from the video taken by the two dimensional camera 11A the attribute data (age, gender, and the like) of the user appearing in the video, individual data (identification information of the regular customer specified by collating the facial image, and the like). In addition, the meta-data conversion unit 22 sends the purchase behavior data of the user appearing in the video (user's product obtained from the shelf, and the like) obtained from the three dimensional camera 12A. The meta-data transmission unit 23 transmits the information to the server terminal device 40. In the server terminal device 40, the big data analysis unit 41 accumulates the information received from the meta-data transmission unit 23. In addition, the big data analysis unit 41 transmits the purchase behavior history, product search history, and the like corresponding to attribute data and individual data about the user received from the meta-data transmission unit 23 to the edge terminal device 20. The purchase behavior history is, for example, information about the product purchased by the user class corresponding to the age group and the gender indicated by the attribute data when receiving the attribute data of the user from the meta-data transmission unit 23. The product search history is information about the products that the user class is searching through the Internet or the like. Even when the individual information about the user is received from the meta-data transmission unit 23, the big data analysis unit 41 also transmits the purchase behavior history and the product search history to the edge terminal device 20.

In the edge terminal device 20, the market data reception unit 24 receives purchase behavior history and product search history of the user and sends them to the interest estimation unit 25. Based on the purchase behavior history and the product search history of the user, The interest estimation unit 25 estimates which of the products exhibited in the exhibition apparatus 30A the user passing in front of the exhibition apparatus 30A is interested in. For example, when the product included in the purchase behavior history and the product search history is exhibited in the exhibition area 31 of the exhibition apparatus 30A, the interest estimation unit 25 estimates that the user has interest in the product. The interest estimation unit 25 sends to the output instruction unit 26 information relating to the product in which the user is considered to be interested. The output instruction unit 26 generates a product exhibition image in which the product estimated by the interest estimation unit 25 is volume-displayed and transmits the product exhibition image to the exhibition apparatus 30. In the exhibition apparatus 30, the control unit 33 receives the product exhibition image and displays the product exhibition image on the output unit 32.

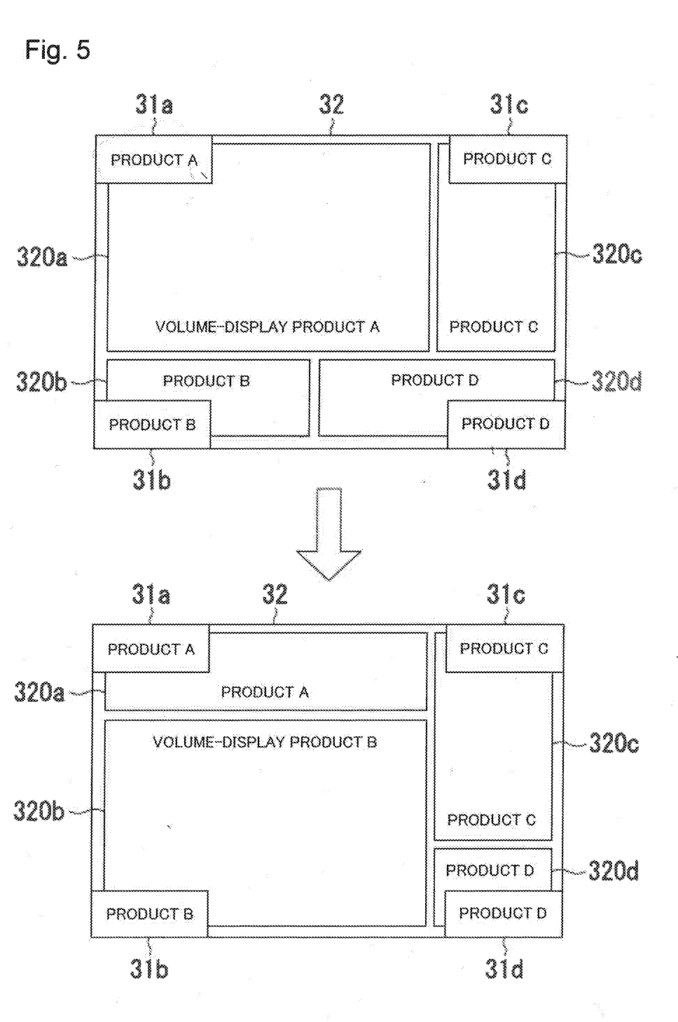

Next, an example of a display mode of the display area which changes according to the interest estimation of the user estimated by the interest estimation unit 25 will be explained with reference to FIG. 5. FIG. 5 shows a first example of the product exhibition image displayed by exhibition apparatus 30. In the exhibition apparatus 30 shown in FIG. 5, four areas (i.e., exhibition areas 31a to 31d) for exhibiting actual products are provided. That is, a product A is exhibited in an exhibition area 31a, a product B is exhibited in an exhibition area 31b, a product C is exhibited in an exhibition area 31c, and a product D is exhibited in an exhibition area 31d. The display screen of the output unit 32 is divided into four display areas (i.e., display areas 320a to 320d) corresponding to products A to D, respectively. In the display area 320a, one or more images of the product A are displayed. Likewise, images of the product B are displayed in the display area 320b, images of the product C are displayed in the display area 320C, and images of the product D are displayed in the display area 320d. When only one full-size image of the product A can be displayed in the display area 320a, the output unit 32 displays one image of the product A. Normally, each display area displays a state in which multiple products are exhibited side by side.

The upper side diagram in FIG. 5 displays the display area 320a of product A in an enlarged manner. It should be noted that “displaying the display area by enlarging the display area” is referred to as volume-display. When the display area 320a is not enlarged, ten images of the product A can be displayed in alignment. For example, in the volume-display, 30 images of the product A can be displayed side by side in the enlarged display area 320a. This can increase the user's attention to the product A. In other words, by performing volume-displaying of the product A, a user who did not care about the display image of output unit 32 of exhibition apparatus 30 may notice the existence of the product A.

Next, it is assumed that the control unit 33 receives a new product exhibition image of the product B volume-displayed from the output control unit 26. Then, the control unit 33 displays the product exhibition image on the output unit 32. The lower side diagram in FIG. 5 is a display example in which the product B is volume-displayed in the display part 320b. Like the upper side diagram of FIG. 5, in the lower side diagram of FIG. 5, the display area 320b is enlarged to display a larger number of images of the product B than the images before enlargement, so that awareness of the product B by the user B can be enhanced.

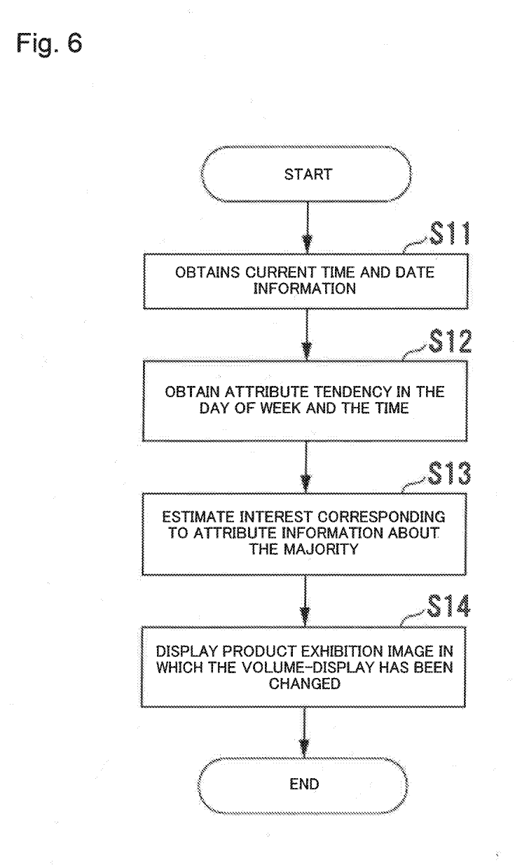

Next, a specific example of processing for changing the volume-display in the display area 320 of the exhibition apparatus 30 will be described. FIG. 6 is a flowchart showing the first example of change control processing of the display area 320 of the exhibition apparatus 30 according to the present embodiment. With reference to FIG. 6, the process of switching the product that performs volume-display in response to to the change of the user class visiting in each time zone will be explained. In this processing, the interest estimation unit 25 estimates which product to volume-display in the time zone at a predetermined time interval based on the interests of the user class visiting during that time zone. In the storage unit 29, visit tendency information indicating the trend of attribute information of visited users for each day of week and time zone (trend of whether user class of specification is the most visited) is stored in advance.

When it is determined that it is time to estimate the product to be subjected to volume-display, the interest estimation unit 25 acquires the current time and date information (step S11). Next, the interest estimation unit 25 refers to the storage unit 29 and reads the attribute information about the user class in which a largest number of people visit the store in the day of week and the time zone indicated by the time and date information (step S12). For example, the interest estimation unit 25 reads from the storage unit 29 the information that there are tendencies for many men in their thirties to visit on a day of week and the time zone indicated by time and date information. The interest estimation unit 25 sends the attribute information thereof to the market data reception unit 24. The market data reception unit 24 requests the server terminal device 40 for market data corresponding to the attribute information. The big data analysis unit 41 transmits the purchase behavior history and the product search history of the user having the attribute information to the market data reception unit 24. The market data reception unit 24 sends the market data to the interest estimation unit 25. The interest estimation unit 25 estimates the interest corresponding to the attribute information about the majority of users visiting on the current day and time zone (step S13). For example, the interest estimation unit 25 extracts the product purchased by a man in his thirties from a purchase behavior history of a male in his thirties received from the big data analysis unit 41, and compares the extracted product with the product in the exhibition area 31 of the exhibition apparatus 30. If the product in the exhibition apparatus 30 contains the same product as or product related to the product recorded in the purchase behavior history, the interest estimation unit 25 indicates that the product is a product which men in their thirties are likely to be interested in.

Next, the interest estimation unit 25 sends to the output instruction unit 26 the information about the product for which interest of the user class has been estimated. The output instruction unit 26 generates a product exhibition image that volume-displays the product in which the user class in which many users are expected to visit the store in the time zone is interested, and transmits the product exhibition image to the exhibition apparatus 30. In the exhibition apparatus 30, the control unit 33 displays the product exhibition image in which the volume-display has been changed (step S14). More specifically, the control unit 33 acquires the product exhibition image via the communication unit 34 and sends the product exhibition image to the output unit 32. The output unit 32 displays the product exhibition image.

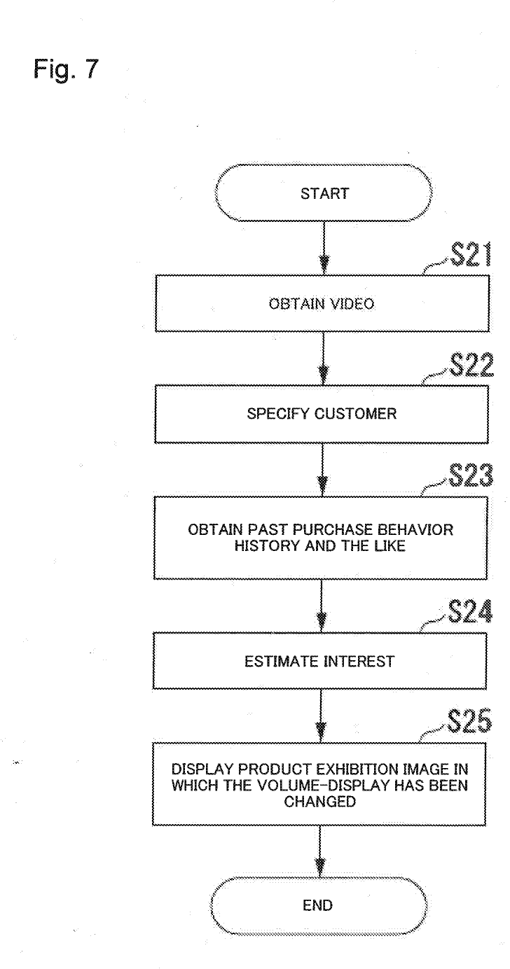

FIG. 7 is a flowchart showing a second example of change control processing of a display area 320 of an exhibition apparatus 30 according to the present embodiment. With reference to FIG. 7, the process of volume-displaying the product that matches the needs of the regular customer who came to the store and the like will be explained. In this processing, the interest estimation unit 25 estimates the product in which the user is interested from the purchase behavior history of the user. The user is, for example, a regular customer, a customer who is a member of the store, and the like. For these users, the information necessary for specifying the user such as facial image is stored in storage unit 29 in advance.

First, the two dimensional camera 11 continues to capture the video of the user visiting the store and sends the image to the video input unit 21. The video input unit 21 inputs the video captured by the two dimensional camera 11 (step S21). Next, the video input unit 21 sends video to the meta-data conversion unit 22. The meta-data conversion unit 22 extracts the facial image of the user appearing in the video and compares it with the facial image of the customer stored in the storage unit 29. When the verification is successful, the meta-data conversion unit 22 specifies that the visited user is the customer who is successfully verified (step S22). The meta-data conversion unit 22 transmits the individual data of the specified customer to the server terminal device 40 via the meta-data transmission unit 23. In the server terminal device 40, the big data analysis unit 41 analyzes the product purchased by the customer indicated by the individual data in the past, and transmits the purchase behavior history including the product information to the market data reception unit 24. The interest estimation unit 25 acquires the past purchase behavior history of the specified customer from the market data reception unit 24 (step S23).

The interest estimation unit 25 estimates the interest of the specified customer (step S24). For example, the interest estimation unit 25 extracts the product purchased by the specified customer from the purchase behavior history and compares the product purchased with the product exhibited in the exhibition apparatus 30. When the product exhibited on exhibition apparatus 30 includes the same product as and product related to the product recorded in purchase behavior history, the interest estimation unit 25 determines that the product is a product in which the customer is interested.

Next, the interest estimation unit 25 sends to the output instruction unit 26 the information about the product in which the customer is estimated to be interested. The output instruction unit 26 generates a product exhibition image which volume-displays the product in which the customer is estimated to be interested, and transmits the product exhibition image to the exhibition apparatus 30. When there are multiple exhibition apparatus exhibition apparatuses 30, the output instruction unit 26 obtains identification information of the two dimensional camera 11 and the like from the video input unit 21, and outputs the product exhibition image to the exhibition apparatus 30 corresponding to the two dimensional camera 11. In the exhibition apparatus 30, the communication unit 34 receives the product exhibition image, and the control unit 33 sends the product exhibition image to the output unit 32. The output unit 32 displays the product exhibition image in which the volume-display has changed (step S25). This can be expected to have an effect of raising interest in the product purchased by the customer in the past and the product related to that customer in relation thereto for the regular customer who passed in front of the exhibition apparatus 30.

When the customer cannot be specified in step S22 of FIG. 7, the attribute data of the user appearing in video may be output. In that case, the big data analysis unit 41 transmits the purchase behavior history corresponding to the attribute data to the edge terminal device 20. In addition, the output unit 32 displays the image volume-displaying the product corresponding to the attribute of the user passing in front of the exhibition apparatus 30. In the above description, the product in which the user is interested is volume-displayed, but in order to extend the interest of user, the product that user has not purchased so far may be volume-displayed to impress the user with that product.

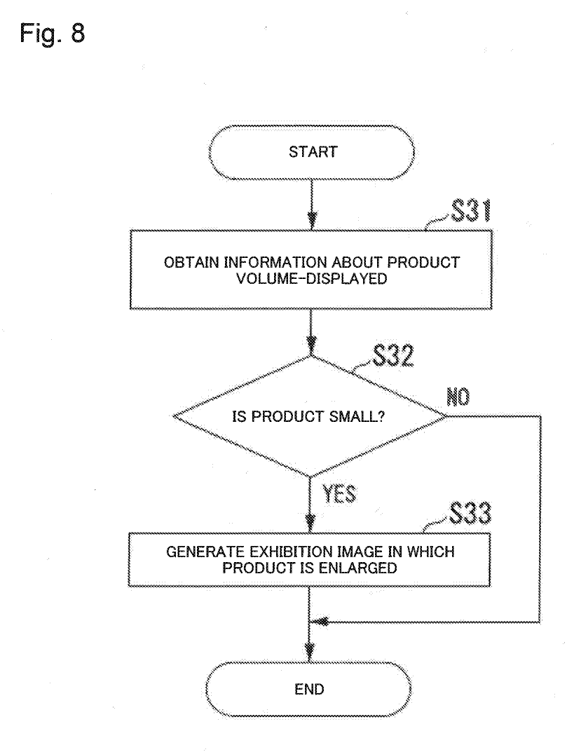

FIG. 8 is a flowchart showing a third example of change control processing of a display area 320 of an exhibition apparatus 30 according to the present embodiment. With reference to FIG. 8, the processing to change the display mode to volume-display according to the attribute of the product exhibited in the exhibition apparatus 30 will be explained. As a premise, it is assumed that the storage unit 29 previously stores the attribute of the product exhibited in the exhibition apparatus 30. Examples of attribute of product includes size, shape, color, design, odor, tactile sense, and the like of the product. It is assumed that the estimation of the product which is volume-displayed is completed by the processing described above before the processing in FIG. 8. In addition, the processing in FIG. 8 is explained as an example for changing the display mode according to the size of product as the attribute of the product.

First, the output instruction unit 26 of the edge terminal device 20 acquires the information about the product which is volume-displayed from the interest estimation unit 25 (step S31). Next, the output instruction unit 26 reads the attribute of the product which is volume-displayed from the storage unit 29. The output instruction unit 26 compares the size information included in the attribute of the product read from the storage unit 29 with a predetermined threshold value to determine whether the product is small (step S32). When the product is not small (determination result “NO” in step S 32), this processing flow is terminated. In this case, the output instruction unit 26 enlarges the display area of the product which is volume-displayed and generates a product exhibition image in which a larger number of products than those in the display area before enlargement are arranged in the enlarged display area. On the other hand, when the product is small (determination result “YES” in step S32), the output instruction unit 26 enlarges the display area of the product which is volume-displayed and also generates a product exhibition image in which the image of the products arranged in the enlarged display area is displayed in an enlarged manner (step S33). The output instruction unit 26 may alternately generate a product exhibition image in which the display area of the product which is volume-displayed is enlarged and a product exhibition image in which the display area of the product is not enlarged with a predetermined time interval.

If a product is a relatively large, even if the product is displayed in full size, the user can see the product. However, in the case of a relatively small product, even if the display area is simply enlarged to generate an image in which a large number of products are arranged, there is a possibility that the user cannot see the product. However, in the processing of FIG. 8, by enlarging and displaying a small product, it is possible for the user to recognize the product. In addition, if the product has a special shape or if a different color or design is applied depending on the viewing direction of the product, the output instruction unit 26 may generate a product exhibition image in which images obtained by photographing the product from various directions are arranged instead of displaying the enlarged display of the product. By displaying the product viewed from various angles using the enlarged display area, the user can be impressed with the shape and design of the product.

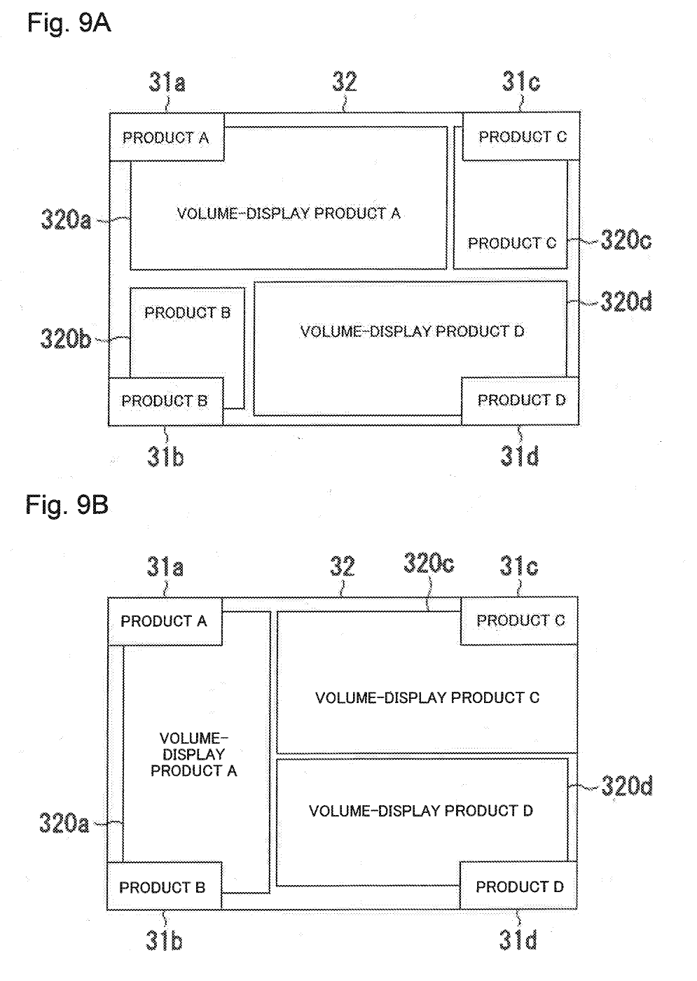

FIGS. 9A to 9D are image diagrams showing other examples of product exhibition images displayed by the exhibition apparatus 30 according to the first embodiment. In this case, the products A to D are exhibited in the exhibition areas 31a to 31d of the exhibition apparatus 30, and the images of the products A to D are displayed in the display areas 320a to 320d, respectively.

FIG. 9A shows the product exhibition image which displays the display areas 320a, 320d corresponding to the two products A, D exhibited in the exhibition areas 31a, 31d in an enlarged manner. The number of products which the interest estimation unit 25 estimates that the user is interested in is not limited to only one. For example, if information that indicates that the product A and the product D are related to each other and the user frequently purchases the product A is included in the purchase behavior history of the user, the interest estimation unit 25 could select not only the product A but also the product D as the product to be volume-displayed. In that case, the output instruction unit 26 generates a product exhibition image in which the product A and the product D are volume-displayed as shown in FIG. 9A.

FIG. 9B shows a product exhibition image which displays display areas 320a, 320c, 320d corresponding to the products A, C, D exhibited in the exhibition areas 31a, 31c, 31d, respectively, in an enlarged manner. When the interest estimation unit 25 estimates that the products A, C, D are the products to be volume-displayed, the output instruction unit 26 generates a product exhibition image in which the products A, C, D are volume-displayed. In this case, as shown in FIG. 9B, only the display areas 320a, 320c, and 320d for volume-displaying the other three products A, C, and D may be provided without providing the display area 320b corresponding to the product B.

FIG. 9C shows a product exhibition image displaying not only the display areas 320a to 320d corresponding to the products A to D exhibited in the exhibition areas 31a to 31d, but also, for example, an advertisement display 320e on any of the products A to D at the center of the output unit 32. For example, when a predetermined period of time elapses since a product exhibition image in which the product which the interest estimation unit 25 estimates that the user is interested in is volume-displayed is generated, the output instruction unit 26 generates a product exhibition image in which the advertisement information 320e as shown in FIG. 9C is embedded in the center of the output unit 32 and transmits the product exhibition image to the exhibition apparatus 30. The exhibition apparatus 30 displays the advertisement information 320e together with the display areas 320a to 320d of the products A to D for a period of time in which no product to be volume-displayed does not exist.

FIG. 9D shows a product exhibition image displaying not only display areas 320a to 320d corresponding to the products A to D exhibited in the exhibition areas 31a to 31d but also, for example, the image 320f of the product F related to any of the products A to D. In this case, on the floor 100 shown in FIG. 4, the product F related to the products A to D exhibiting in the exhibition apparatus 30A is exhibited in the shelf 130A. Then, when the product which the interest estimation unit 25 estimates that the user class who is considered to come to the store in any given time zone in any given day of week is interested in is the product F, the output instruction unit 26 generates a product exhibition image including the image 320f in which the product F is volume-displayed. With this product exhibition image, the user going to the shelf 130A can be prompted to notice the product F. As described above, the product exhibition image can be utilized as means for raising the interest of the user in not only the product exhibited in the exhibition area 31 but also the product exhibited at the other shelf 130.

It should be noted that the product exhibition image is not limited to the example shown in FIG. 9A to FIG. 9D, but other example exhibition image examples may be designed. For example, the interest estimation unit 25 randomly may select any number of products among the products A to D. The output instruction unit 26 may generate a product exhibition image volume-displaying all the selected products, and transmit the product exhibition image to the exhibition apparatus 30. These processes may be repeatedly executed at predetermined time intervals (for example, several minutes).

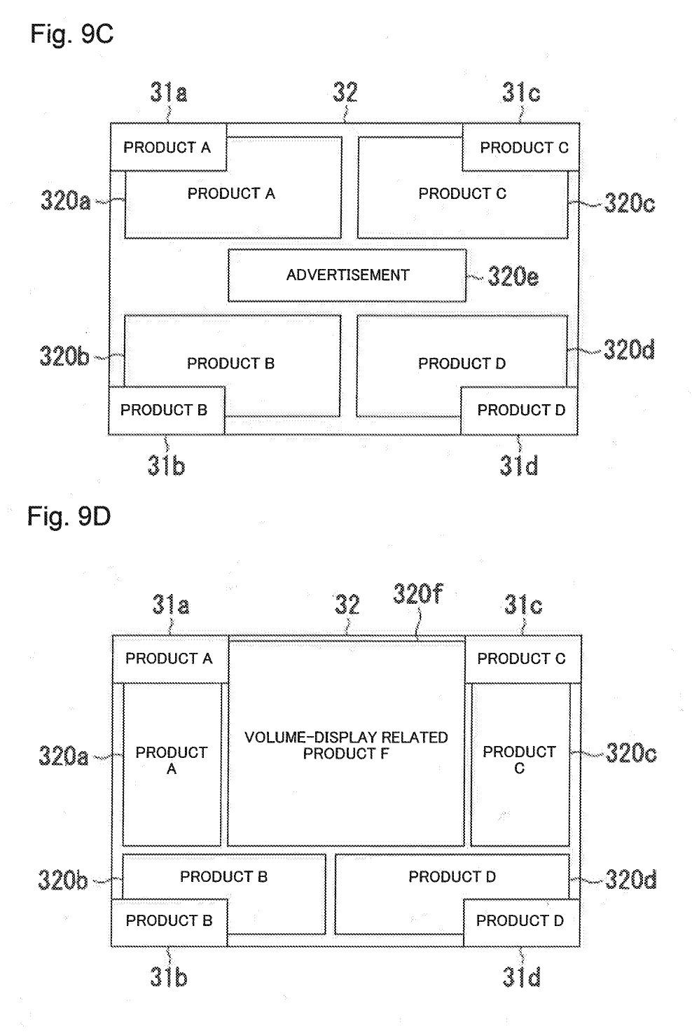

FIG. 10 is an image diagram showing another example of the product exhibition image displayed by the exhibition apparatus 30 according to the first embodiment. FIG. 5 and FIGS. 9A to 9D show product exhibition images in which a plurality of display areas corresponding to a plurality of products are provided and the display mode of the display area for each product is controlled so as to attract user's interest. FIG. 10 shows the product exhibition image displaying only one display area for one product. In FIG. 10, the product B is exhibited in the exhibition area 31b of the exhibition apparatus 30, and any product is not exhibited in the other exhibition areas 31a, 31c, and 31d. Further, the output unit 32 generates a product exhibition image including only the display area 320b corresponding to the product B. In the display area 320b, one or more images of the product B are displayed.

The upper side diagram in FIG. 10 shows the product exhibition image without volume-displaying product B. If product-B is not volume-displayed, other products are not displayed in areas other than the display area 320b corresponding to product B, and colors such as for example, black are displayed. Alternatively, advertisement information and the like may be displayed. The lower side diagram in FIG. 10 shows the product exhibition image when the product B is volume-displayed. By performing volume-display, the image in which an image arranged with more products B than the image in the lower side diagram can be displayed. In particular, in FIG. 10, since the exhibition apparatus 30 displays only the display area 320b corresponding to one product B, the display area 320b can be enlarged to the entire output unit 32, and therefore, as compared with the case of displaying a plurality of products by exhibiting them, it is possible to expect an effect to further make the individual product to stand out and to attract the user. As described above, according to the present embodiment, it is possible to attract users' interests by volume-display and increase the awareness of that product, no matter whether there is only one type of product or multiple types of products to be exhibited.

In the volume-display in the above product exhibition image, the display area is enlarged, and in the enlarged display area, a larger number of products are displayed than the products displayed in the display area before enlargement, but the embodiment is limited thereto. For example, it is possible to change the background color of the enlarged display area or the product color, or enlarge and display the image of product in the enlarged display area.

Alternatively, the exhibition apparatus 30 may be provided with a tank filled with the odor particles of the product to be exhibited and means to release odor particles. In this way, in addition to the volume-display of the product, the odor of the product may be released. Alternatively, a tactile sense such as hardness, softness, and operation property of the product to be volume-displayed may be presented using ultrasonic haptics technology.

According to the exhibition apparatus 30 according to the present embodiment, by changing the display mode of the display area 320 according to the user's interest, it is possible to raise user's awareness in the product and to stimulate purchase motivation. Since actual product is exhibited in the exhibition area 31 of the exhibition apparatus 30, the volume-display allows the user who is interested in the product to pick up the product to review the product.

In the present embodiment, the attribute and individual user are specified according to the image detected by the image sensor, but the embodiment is not limited thereto. The means for detecting the attribute of the user and the like is not limited to the image sensor. For example, instead of the image sensor, a reading device of an IC card possessed by the user may be placed near the exhibition apparatus 30. In that case, when the user holds the IC card over the reading device, the reading device reads the individual information about the user recorded on the IC card, and the interest estimation unit 25 estimates the customer's interest based on the individual information.

### Second Embodiment

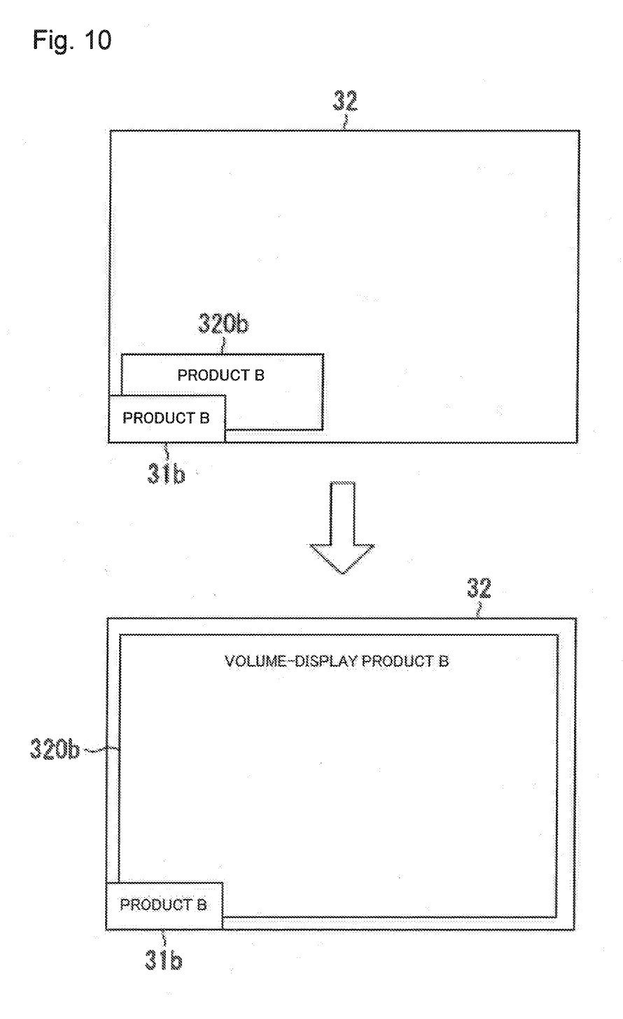

Next, an exhibition system 2 according to a second embodiment of the present invention will be explained with reference to FIGS. 11 to 14. In the second embodiment, in addition to the function of the first embodiment, the second embodiment has a function of controlling whether or not volume-display of the product exhibition image is performed according to the distance between the user and the exhibition apparatus 30. With respect to the exhibition system 2 according to the second embodiment, the detailed description about the same constituent elements and functions, as those of the exhibition system 1 according to the first embodiment, are omitted.

FIG. 11 is a block diagram of the exhibition system 2 according to the second embodiment of the present invention. Like the exhibition system 1 according to the first embodiment, the exhibition system 2 according to the second embodiment has a store video sensor 10, an exhibition apparatus 30, a server terminal device 40, and a store terminal device 50. On the other hand, the exhibition system 2 has an edge terminal device 201 in place of the edge terminal device 20. Like the edge terminal device 20, the edge terminal device 201 has constituent elements 21 to 25 and 27 to 29. In addition, the edge terminal device 201 has an output instruction unit 261 in place of the output instruction unit 26 and a distance estimation unit 251. The distance estimation unit 251 acquires the video taken by the two dimensional camera 11 from the video input unit 21. The distance estimation unit 251 estimates the distance between the user and the exhibition apparatus 30 attached to the two dimensional camera 11 using the user and the shelf set around the user appearing in the video. The distance estimation unit 251 sends the estimated distance information to the output instruction unit 261. In addition to the function of the output instruction unit 26 described in the first embodiment, the output instruction unit 261 has a function of generating a product exhibition image which is volume-displayed according to the distance between the user and the exhibition apparatus 30.

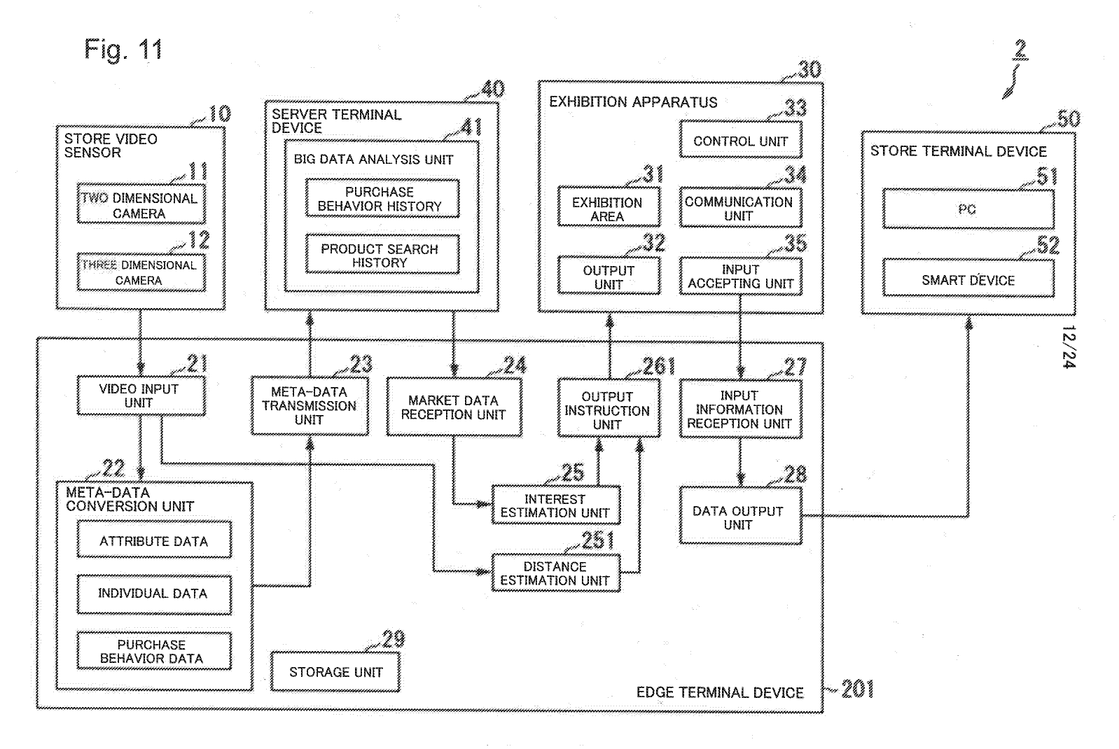

FIG. 12 is a layout showing an example of the floor 101 to which the exhibition system 2 according to the second embodiment of the present invention is applied. The floor 101 is provided with an edge terminal device 201, an exhibition apparatus 30E, a cash register 111, a cash register shelf 121, and shelfs 131A to 131K. In the exhibition apparatus 30E, a two dimensional camera 11E and a three dimensional camera 12E are mounted. The two dimensional camera 11E photographs the user approaching the exhibition apparatus 30E. The three dimensional camera 12E photographs the user's action in front of the shelf. The exhibition apparatus 30E is installed on the far side of the floor 101 (i.e., the side opposite to the entrances 141A, 141B). For example, the floor 101 is a store of a furniture dealer, and the exhibition apparatus 30E exhibits expensive furniture and trendy furniture (hereinafter referred to as the product E). Meanwhile, the shelfs 131A to 131K exhibit furniture according to the type of the product. Here, the shelfs 131A to 131K are collectively called shelfs 131.

When the distance between the user and the exhibition apparatus 30E is greater than or equal to a predetermined threshold value based on the distance estimated based on the image of the user included in the video captured by the two dimensional camera 11E, the exhibition apparatus 30E is performs volume-display for the product E. This makes it possible to make the user the user who is away from the exhibition apparatus 30E to be impressed with the product E.

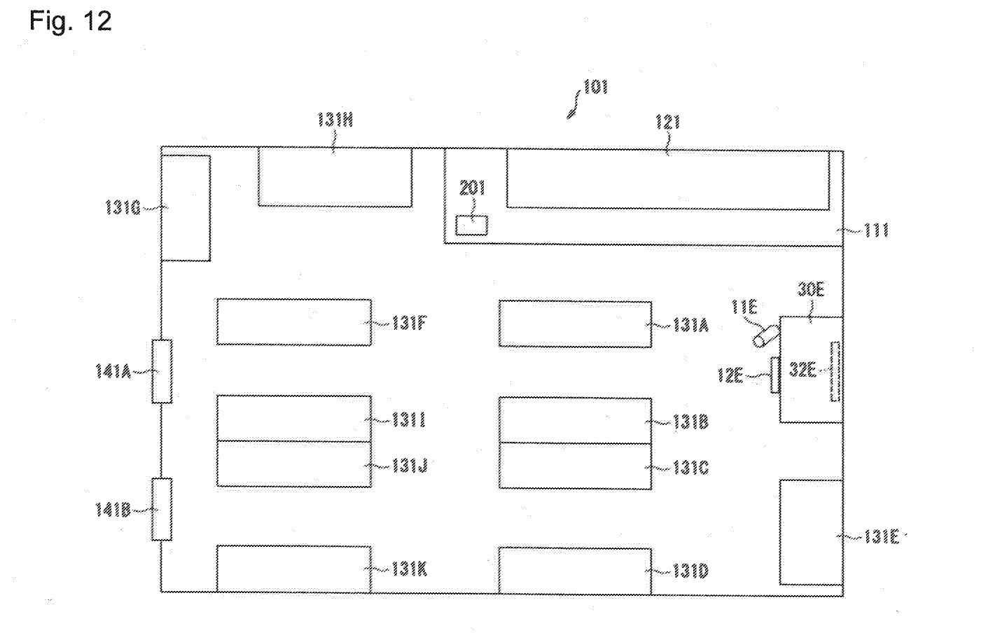

FIG. 13 is an image diagram showing a seventh example of a product exhibition image displayed by an exhibition apparatus 30E according to the second embodiment. Here, the product E is exhibited in the exhibition area 31b of the exhibition apparatus 30E. In the other exhibition areas 31a, 31c, 31d of the exhibition apparatus 30E, the product is not exhibited. A display area 320b corresponding to the product E is provided in the output unit 32. In the display area 320b, one or more images of product E are displayed.

The upper side diagram of FIG. 13 shows that the product E is volume-displayed in the display area 320b. When the user does not exist within the predetermined distance from the exhibition apparatus 30E, the exhibition apparatus 30E volume-displays the product E. As a result, it is possible to cause the user who is located away from the exhibition apparatus 30E within the floor 101 to recognize the product E as well. Next, when the user who is interested in the product E by looking at the volume-displayed product E approaches within a predetermined distance from the exhibition apparatus 30E, the exhibition apparatus 30E changes the display content of the output unit 32 to the lower side diagram of FIG. 13. In the lower side diagram of FIG. 13, the screen is divided into left half and right half areas, and the display image of the product E is displayed in the left half area, and the display product explanation of the product E is displayed in the right half area. As a result, a user who is interested in the product E can gain deeper knowledge about the product E.

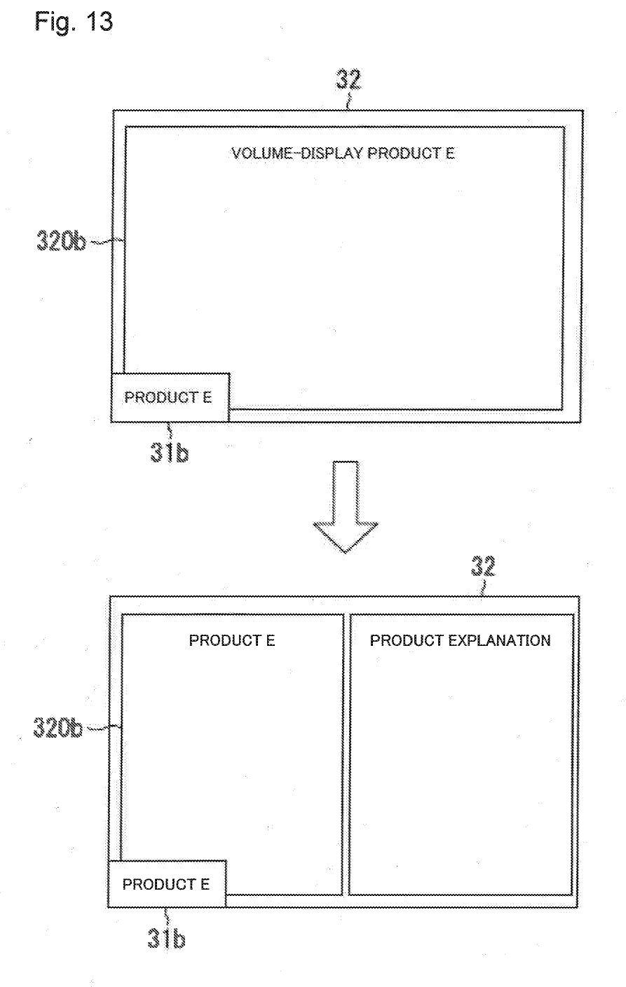

FIG. 14 is a flowchart showing change control processing of a display area of an exhibition apparatus 30E according to the second embodiment of the present invention. Here, the exhibition apparatus 30E is installed on the far side in the floor 101 shown in FIG. 12, and it is assumed to display the product exhibition image explained in FIG. 13. A processing that performs volume-display of the product E according to the distance between the user and the exhibition apparatus 30E will be explained.

First, the two dimensional camera 11E continues to take the video of the user in the store, and sends the video to the video input unit 21. The video input unit 21 sends the video taken by the two dimensional camera 11E to the distance estimation unit 251. The distance estimation unit 251 analyzes the video, and estimates the distance between the exhibition apparatus 30E provided with the two dimensional camera 11E taking the video and the user appearing in the video. For example, the distance estimation unit 251 estimates the distance between the user and the exhibition apparatus 30E based on the positional relationship between the user and the shelf 131 around the user in the video. The distance estimation unit 251 sends the estimated distance to the output instruction unit 261. The output instruction unit 261 determines whether or not the user exists within a predetermined distance from the exhibition apparatus 30E (step S41).

When it is determined that the user exists within the predetermined distance from the exhibition apparatus 30E (determination result “YES” in step S41), the output instruction unit 261 generates a product exhibition image including the image of the product E and the product explanation of the product E. The output instruction unit 261 sends the product exhibition image to the exhibition apparatus 30E. In the exhibition apparatus 30E, the control unit 33 causes the output unit 32 to display the product exhibition image including the image of the product E and the product explanation of the product E (step S42).

On the other hand, when it is determined that the user does not exist within the predetermined distance from the exhibition apparatus 30E (determination result “NO” in step S41), the output instruction unit 261 generates a product exhibition image in which the product E is volume-displayed. The output instruction unit 261 transmits the product exhibition image to the exhibition apparatus 30. In the exhibition apparatus 30E, the control unit 33 displays the product exhibition image in which the product E is volume-displayed on the output unit 32 (step S43).

For the second embodiment of the present invention, various modifications may be considered. For example, a transmitter of a beacon signal is distributed to the user at entrances 141A, 141B of the floor 101. In the vicinity of the exhibition apparatus 30E, a receiver of the beacon signal is set up, and when the user approaches, the receiver receives the beacon signal and detect that the user is approaching. At this time, the receiver transmits a signal indicating that user is approaching to the edge terminal device 201. In the edge terminal device 201, the distance estimation unit 251 receives that signal. When the distance estimation unit 251 receives the signal, the distance estimation unit 251 sends a distance in which the beacon signal can be detected to the output instruction unit 261. The output instruction unit 261 generates a product exhibition image in which the product is volume-displayed according to the distance. The exhibition apparatus 30E displays the product exhibition image.

In the present embodiment, as another method of estimating the distance between the user and the exhibition apparatus 30E, a pressure sensor may be provided on the floor of the passage from the entrances 141A, 141B to the exhibition apparatus 30E in the floor 101. When the pressure sensor detects the weight of a person, the distance between the user and the exhibition apparatus 30E may be estimated based on the installation position of the pressure sensor and the installation position of the exhibition apparatus 30E. This is not limited to the pressure sensor that is installed in the passage inside the floor 101. For example, a person detection sensor may be provided in the passage leading to the exhibition apparatus 30E within the floor 101. In this case, the distance between the user and the exhibition apparatus 30E may be estimated based on the installation position of the person detection sensor that detects a passing person and the installation position of the exhibition apparatus 30E.

### Third Embodiment

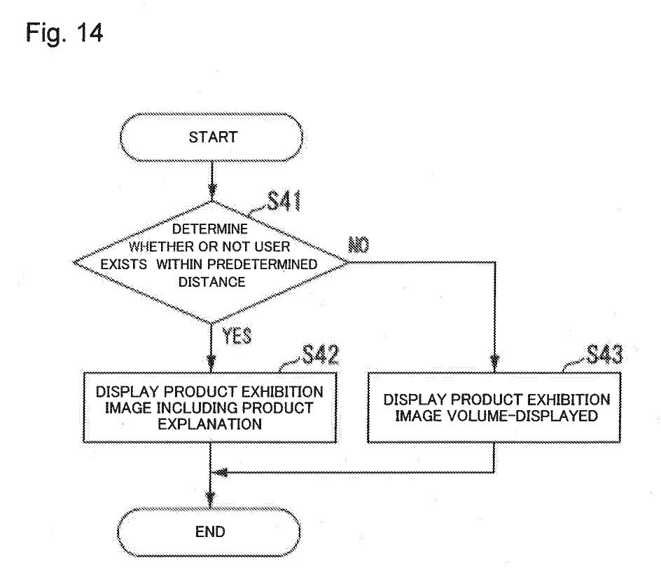

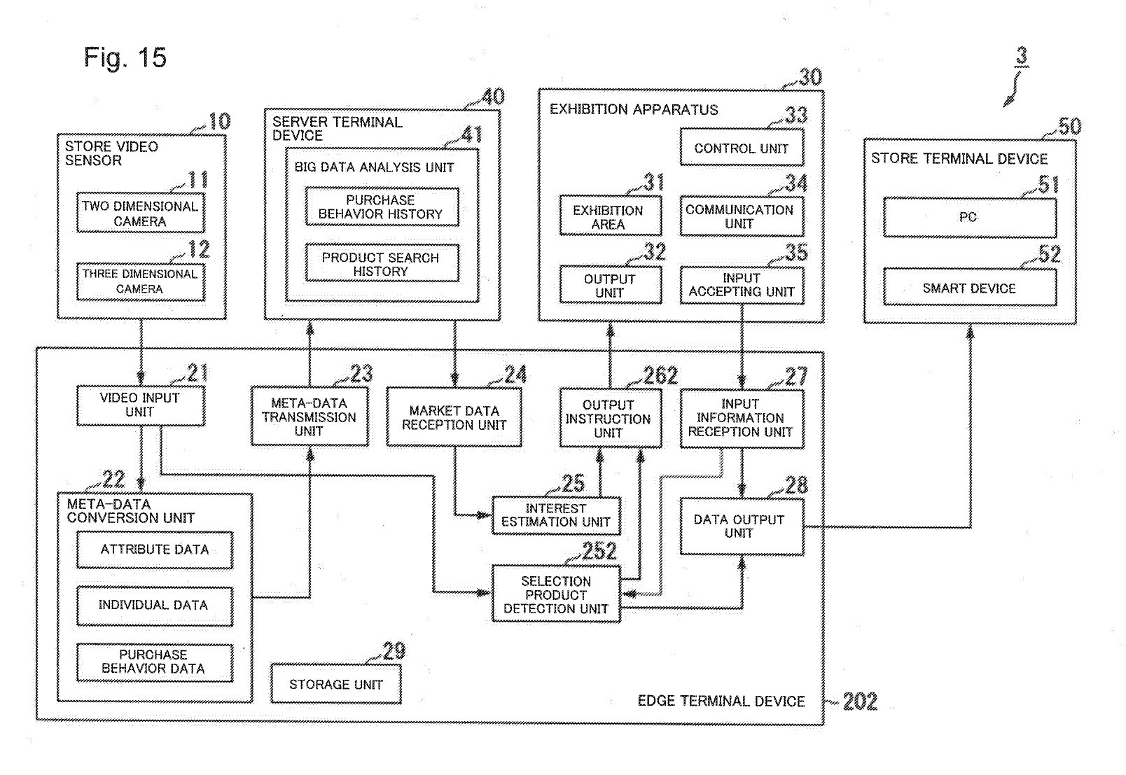

Next, an exhibition system 3 according to the third embodiment of the present invention will be explained with reference to FIGS. 15 to 16. In the third embodiment, in addition to the function of the first embodiment, the third embodiment has a function to perform volume-display of a product based on selection operation performed by the user for the product exhibited in the exhibition apparatus 30. For the exhibition system 3 according to the third embodiment, the detailed explanation on constituent elements and functions similar to the exhibition system 1 according to the first embodiment is omitted.

FIG. 15 is the block diagram illustrating the exhibition system 3 according to the third embodiment of the present invention. The exhibition system 3 according to the third embodiment has a store video sensor 10, an exhibition apparatus 30, a server terminal device 40, and a store terminal device 50, like the exhibition system 1 according to the first embodiment. On the other hand, the exhibition system 3 has an edge terminal device 202 in place of the edge terminal device 20. Like the edge terminal device 20, the edge terminal device 202 has constituent elements 21 to 25 and 27 to 29. In addition, instead of the output instruction unit 26, the edge terminal device 202 has an output instruction unit 262 and a selection product detection unit 252. The selection product detection unit 252 acquires the video taken by the two dimensional camera 11 and the three dimensional camera 12 from the video input unit 21. The selection product detection unit 252 collates the image of the product picked up by the user among the products appearing on the video exhibited on the exhibition apparatus 30 with the image of each product recorded in the storage unit 29 in advance, and specifies which product the user picked up. The selection product detection unit 252 sends the information of the specified product to the output instruction unit 262. In addition to the function of the output instruction unit 26 according to the first embodiment, the output instruction unit 262 has a function of generating a product exhibition image which volume-displaying on the product selected by the user. It should be noted that other configurations and functions according to the third embodiment are similar to those of the first embodiment, but a combination of the third embodiment and the second embodiment is also possible.

FIG. 16 is a flowchart showing the change control processing of the display area of the exhibition apparatus 30 according to the third embodiment of the present invention. As a premise, the two dimensional camera 11 is installed so as to be able to photograph the product which the user picked up, out of the products exhibited on the exhibition apparatus 30. First, the two dimensional camera 11 continues to capture the video of the user in the store, and sends the video to the video input unit 21. In addition, the three dimensional camera 12 continues to capture the user's action in front of the shelf and sends the video to the video input unit 21. The video input unit 21 sends the video taken by the two dimensional camera 11 and the three dimensional camera 12 to the selection product detection unit 252. The selection product detection unit 252 analyzes the video and specifies the product selected by the user if there is a product picked by the user (step S51). For example, the selected product detection unit 252 specifies the product that the user has picked up with the video taken by the three dimensional camera 12. Alternatively, the selection product detection unit 252 calculates the degree of similarity between the image of product recorded in advance in the storage unit 29 and the image captured by the two dimensional camera 11, and when the similarity is equal to or greater than a predetermined threshold value, the selection product detection unit 252 specifies that the image taken by the two dimensional camera 11 is the product recorded in the storage unit 29 in advance. The selection product detection unit 252 sends the information of the specified product to the output instruction unit 262. The output instruction unit 262 generates a product exhibition image in which the product specified by the selection product detection unit 252 is volume-displayed. The output instruction unit 262 transmits the product exhibition image to the exhibition apparatus 30. In the exhibition apparatus 30, the control unit 33 displays the product exhibition image including the volume-displayed product (step S52).

In conjunction with the processing described above, the following processing may be executed. For example, in the store, for luxuries and the like, empty box may be exhibited instead of the actual products. For this reason, the exhibition apparatus 30 exhibits empty boxes of luxuries. When the user picks up the empty box, the selection product detection unit 252 analyzes the video taken by the two dimensional camera 11 and the three dimensional camera 12 and specifies the product of the empty box which the user has picked up. The selection product detection unit 252 sends the information of the specified product to the data output unit 28. The data output unit 28 transmits the information about the luxury selected by the user to the PC 51 installed in the cash register. The employee in charge of the cash register acquires the information about the luxury notified to the PC 51, and prepares the luxury in the cash register in advance. This eliminates the need for the user to search for luxuries after presenting an empty box with the cash register, thereby improving work efficiency and reducing user's waiting time.

The method of specifying the product selected by the user is not limited to the above method, and other methods can be adopted. For example, the user may activate an application program (hereinafter referred to as a dedicated application) cooperating with the exhibition system 3 on the portable terminal owned by the user. In this case, the user searches for the product exhibited on the exhibition apparatus 30 within the predetermined range from the exhibition apparatus 30 using the dedicated application. Then, the dedicated application transmits the information about the product searched by the user and the position information about the portable terminal possessed by the user to the edge terminal device 202. In the edge terminal device 202, the selection product detection unit 252 receives the information. The selection product detection unit 252 specifies the exhibition apparatus 30 installed at the position where the user exists from the position information of the portable terminal. The selection product detection unit 252 determines whether or not the product searched by the user is exhibited in the specified exhibition apparatus 30. In the case where the product searched by the user is exhibited in the exhibition apparatus 30 specified by the user, the selection product detection unit 252 sends the specification information of the specified exhibition apparatus 30 and the information of the product searched by the user to the output instruction unit 262. The output instruction unit 262 creates a product exhibition image in which the product searched by the user is volume-displayed. The output instruction unit 262 transmits the product exhibition image to the exhibition apparatus 30 indicated by the identification information.

A display in which the output unit 32 is integrated with the touch panel may be adopted. In this case, in the display area 320 corresponding to the product exhibited in the exhibition area 31, a selection button as well as image is displayed in the product. When the user touches the selection button, the input accepting unit 35 transmits the information about the product selected by the user to the edge terminal device 202. In the edge terminal device 202, the input information reception unit 27 receives the product information and sends the product information to the selected product detection unit 252. The output instruction unit 262 generates a product exhibition image in which the product selected by the user is volume-displayed. The exhibition apparatus 30 displays its product exhibition image.

The following processing may be added in conjunction with the processing described above. For example, in stores that sell drugs, there is a product that users cannot purchase unless the explanation is received from the pharmacist. The exhibition apparatus 30 shows an empty box of such a specification product. The product purchase button is displayed in the display area 320 of the exhibition apparatus 30 corresponding to the specification product. When the user operates the product purchase button, the input accepting unit 35 transmits the information of the product corresponding to the product purchase button operated by the user to the edge terminal device 202. In the edge terminal device 202, the input information reception unit 27 receives the product information and sends the product information to the data output unit 28. The data output unit 28 transmits the information about the product purchased by the user to the PC 51 installed in the cash register. The pharmacist prepares the product notified by the PC 51 in the cash register. When the user arrives at the cash register, the pharmacist explains about the product. As a result, it is possible to improve the ease of shopping by assisting the purchase behavior of the user.

In the present embodiment, an acceleration sensor may be attached to the product in order to detect operation of the user, or a weight sensor may be provided in the product exhibition surface (or product exhibition shelf) of the exhibition area 31. The acceleration sensor detects the acceleration caused when the user picks up the product, and the weight sensor detects the weight change that occurs when the user picks up the product. In this way, based on the acceleration sensor and the detection result of the weight sensor, volume-display may be performed on the display area 320 corresponding to the product the user has picked up.

### Fourth embodiment

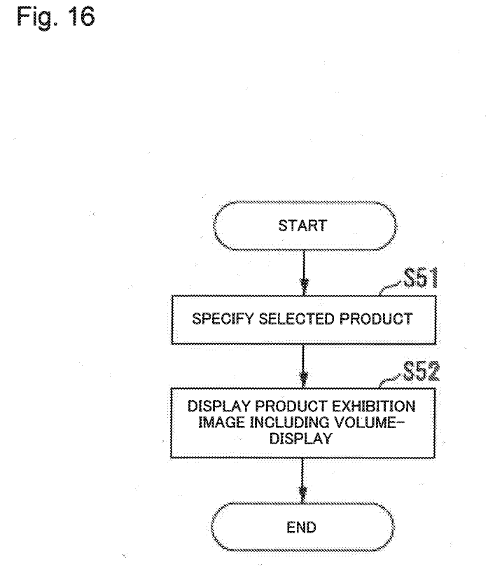

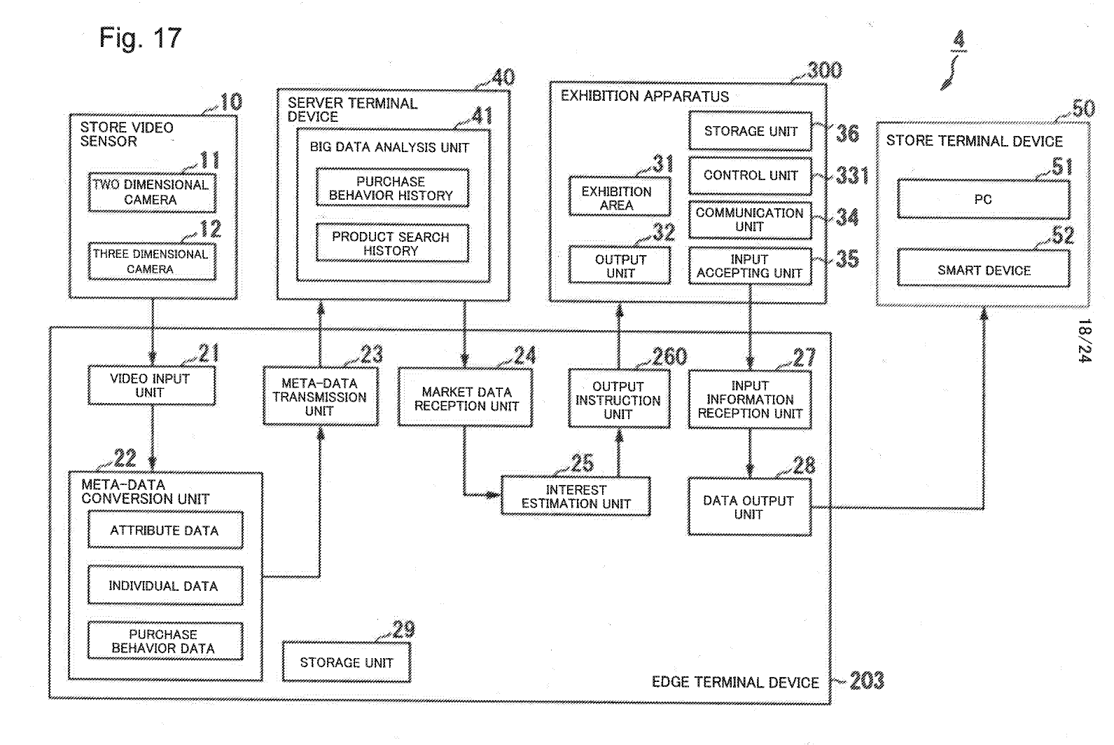

Next, an exhibition system 4 according to the fourth embodiment of the present invention will be explained with reference to FIGS. 17 to 18. In the third embodiment, instead of causing the edge terminal device 20 to create a volume-displayed product exhibition image and transmits the product exhibition to the exhibition apparatus 30, the exhibition apparatus 30 generates and displays the product exhibition image. With regard to the exhibition system 4 according to the fourth embodiment, the detailed explanation about the same configuration and function as the exhibition system 1 according to the first embodiment is omitted.

FIG. 17 is the block diagram of the exhibition system 4 according to the fourth embodiment of the present invention. Like the exhibition system 1 according to the first embodiment, the exhibition system 4 according to the fourth embodiment includes a store video sensor 10, a server terminal device 40, and a store terminal device 50. An edge terminal device 203 is provided instead of the edge terminal device 20, and an exhibition apparatus 300 is provided instead of the exhibition apparatus 30. The edge terminal device 203 includes constituent elements 21 to 25 and 27 to 29 of the edge terminal device 20 and an output instruction unit 260 instead of the output instruction unit 26. In addition, the exhibition apparatus 300 includes constituent elements 31, 32, 34, and 35 of the exhibition apparatus 30, a control unit 331 in place of the control unit 33, and a storage unit 36.

The output instruction unit 260 of the edge terminal device 203 transmits instruction information including the identification information of the product to be volume-displayed to the exhibition apparatus 300. The storage unit 36 of the exhibition apparatus 300 stores the image to be displayed in the display area 320 of the output unit 32. For example, the storage unit 36 is a hard disk included in the exhibition apparatus 300, a USB memory connected to the exhibition apparatus 300, and the like. The control unit 331 has a function of reading the image from the storage unit 36 and generating a product exhibition image. It should be noted that the other configurations and functions of the exhibition system 4 are similar to those of the exhibition system 1, but it is also possible to combine the fourth embodiment with the second embodiment and the third embodiment.

FIG. 18 is a flowchart of change control processing of the display area 320 of the exhibition apparatus 300 according to the fourth embodiment of the present invention. With reference to the flowchart of FIG. 18, the processing of the fourth embodiment will be explained which corresponds to the processing to switch the product to volume-display in response to the change of the user class visiting each time zone explained in FIG. 6. The flowchart of FIG. 18 has the same steps S11 to S14 as in FIG. 6 and introduces a new step S135.

On the premise, in the exhibition apparatus 300, the control unit 331 reads the image corresponding to the product exhibited in the exhibition area 31 from the storage unit 36 to generate the product exhibition image, and the output unit 32 displays the product exhibition image.

First, the interest estimation unit 25 determines that it is time to estimate the product to be subjected to volume-display and acquires the current time and date information (step S11). Next, the interest estimation unit 25 reads from the storage unit 29 the attribute information about the user class visiting the store most frequently on the day of week indicated by the time and date information and the time zone (step S12). In addition, the interest estimation unit 25 estimates the user's interest indicated by the attribute information about the user class in which a largest number of users visit the store in the time zone on the current day of week and time zone (step S13). Next, the interest estimation unit 25 sends the information about the product in which the user is estimated to be interested to the output instruction unit 260. The output instruction unit 260 transmits the identification information of the product to the exhibition apparatus 300 (step S135). In the exhibition apparatus 300, the control unit 33 acquires the identification information of the product via the communication unit 34. The control unit 33 generates a product exhibition image in which the product corresponding to the identification information is volume-displayed, and sends the product exhibition image to the output unit 32. The output unit 32 displays the product exhibition image (step S14).

In the present embodiment, when a USB memory, the image of the product displayed in the product exhibition image can be easily switched. If user classes coming to visit the store are different depending on, for example, time zone, it may be desired to display different images depending on age of specification even for the same product. According to the present embodiment, for example, multiple USB memories that stores images of products may be prepared for different target ages, and the product exhibition image can be easily switched by replacing the USB memory according to the ages in which many users visit the store in each time zone. Even when the product to be exhibited in the exhibition area 31 is switched according to the time zone, it is possible to easily change the product exhibition image according to product switching by using the USB memories as shown in the present embodiment.

The control unit 331 may have a function of determining whether or not to change the display area 320 based on at least one of real object information and moving object information. For example, the storage unit 29 associates and stores information indicating the size of the product and the image of the product, and the control unit 331 determines to change the display mode of the product display area 320 of that product in a case where the size of the product exhibited in the exhibition area 31 (the real object information) is smaller than the predetermined threshold value. Then, the control unit 331 generates a product exhibition image in which the product is volume-displayed with a predetermined time interval, and sends the product exhibition image to the output unit 32. Alternatively, an acceleration sensor is attached to the product, and the control unit 331 is configured to acquire the acceleration detected by the acceleration sensor. Then, in the case where the acceleration (moving object information) acquired from the acceleration sensor is greater than or equal to a predetermined threshold value, the control unit 331 determines that the user has picked up the product and hence determines to volume-display the product. Thereafter, the control unit 331 generates a product exhibition image in which the product is volume-displayed.

### Fifth Embodiment

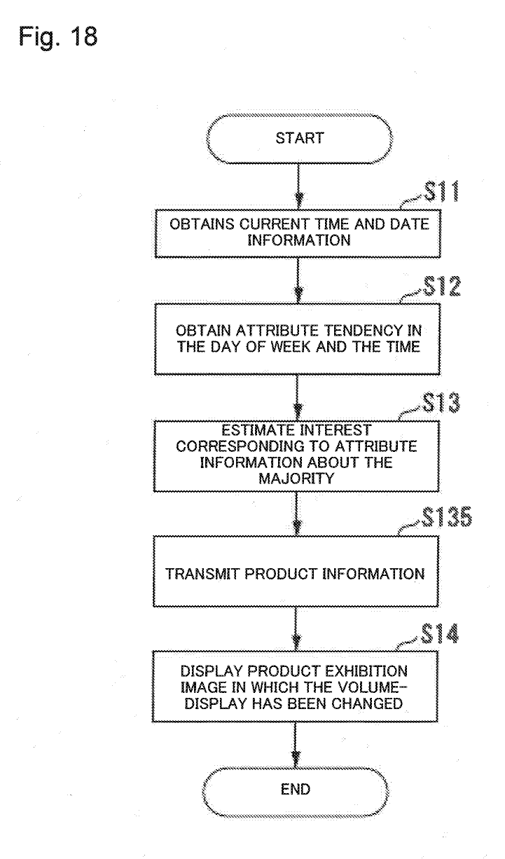

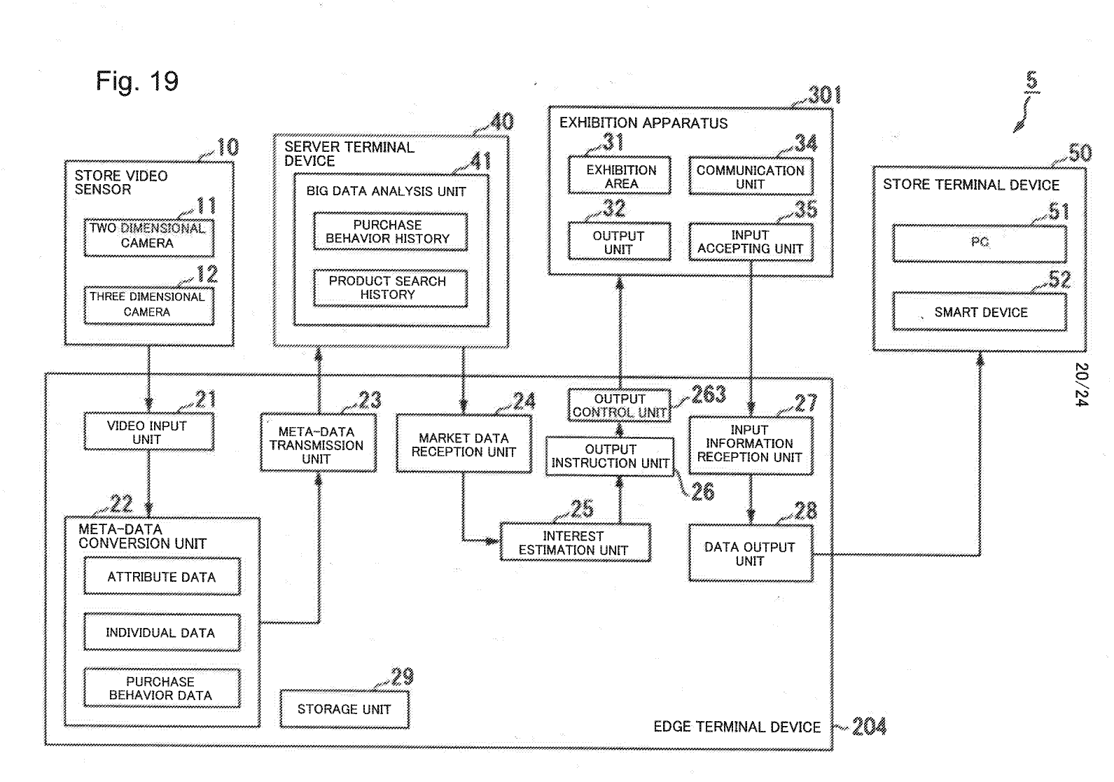

Next, the exhibition system 5 according to the fifth embodiment of the present invention will be explained with reference to FIGS. 19 to 20. In the fifth embodiment, the edge terminal device 204 implements the function of the control unit 33 of the exhibition apparatus 30. With regard to the exhibition system 5 according to the fifth embodiment, the detailed explanation about the same configuration and function as the exhibition system 1 according to the first embodiment is omitted.

FIG. 19 is a block diagram of the exhibition system 5 according to the fifth embodiment of the present invention. Like the exhibition system 1 according to the first embodiment, the exhibition system 5 according to the fifth embodiment has a store video sensor 10, a server terminal device 40, and a store terminal device 50. In addition, an edge terminal device 204 is provided instead of the edge terminal device 20, and an exhibition apparatus 301 is provided instead of the exhibition apparatus 30. The exhibition apparatus 301 has constituent elements 31, 32, 34, 35 other than the control unit 33 of the exhibition apparatus 30. The edge terminal device 204 has the constituent elements 21 to 29 of the edge terminal device 20, and a new output control unit 263 is provided. The output control unit 263 changes the display mode of the display area 320 of the output unit 32 of the exhibition apparatus 301 based on at least one of real object information and moving object information. The other configuration and functions of the exhibition system 5 are similar to those of the exhibition system 1, but it is also possible to combine the fifth embodiment with the second embodiment or the third embodiment.

FIG. 20 is a flowchart showing change control processing of the display area 320 of the exhibition apparatus 301 according to the fifth embodiment of the present invention. With reference to the flowchart in FIG. 20, the processing of the present embodiment will be explained, which corresponds to the processing to switch the product to volume-display in accordance with the change of the user class visiting the store in each time zone explained in FIG. 6. The flowchart of FIG. 20 has steps S11 to S13 as in the flowchart of FIG. 6, and step S141 in place of step S14.

When it is determined that it is time to estimate the product to be subjected to volume-display, the interest estimation unit 25 acquires the current time and date information (step S11). Next, the interest estimation unit 25 reads from the storage unit 29 the attribute information about the user class in which a largest number of people visit the store in the day of week and the time zone indicated by the time and date information (step S12). Thereafter, the interest estimation unit 25 estimates the user's interest indicated by the attribute information about the user class in which a largest number of users visit the store in the time zone on the current day of week and time zone (step S13). Next, the interest estimation unit 25 sends the information about the product in which the user is estimated to be interested to the output instruction unit 260. The output instruction unit 26 generates a product exhibition image that volume-displays the product in which the user class in which many users are expected to visit the store in the time zone is interested, and transmits the product exhibition image to the output control unit 263. The output control unit 263 transmits the product exhibition image to the exhibition apparatus 301 and displays the product exhibition image on the output unit 32 of the exhibition apparatus 301 (step S141). In the exhibition apparatus 301, the output unit 32 displays the product exhibition image. According to the present embodiment, since the function of the control unit 33 is ported to the edge terminal device 204, the weight of the exhibition apparatus 301 can be reduced and the transportability can be improved.

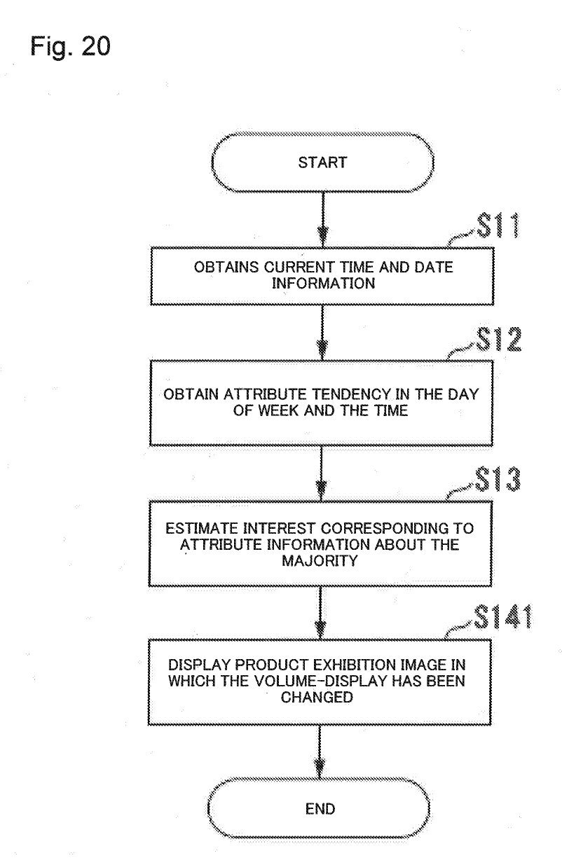

Next, the network configuration applied to exhibition systems 1 to 5 according to the first embodiment to the fifth embodiment of the present invention will be explained. FIG. 21 is a network diagram showing the first network configuration applied to the exhibition system according to the present invention. In the first network configuration shown in FIG. 21, the function of the edge terminal device 20 is installed in the store. Here, the store video sensor 10, the edge terminal device 20, the exhibition apparatus 30, and the store terminal device 50 are connected to the LAN on the store side. The LAN on the store side is connected to a network 61 such as the Internet and a carrier network via a gateway 60. The edge terminal device 20 communicates with the server terminal device 40 installed in the data center via the network 61. The first network configuration is applicable not only to the exhibition system 1 according to the first embodiment but also to the exhibition system 2, 3 according to the second embodiment and the third embodiment.

It is also possible to add a module having the function of a part or all of the server terminal device 40 to the edge terminal device 20. For example, the edge terminal device 20 may be configured to be equipped with the function of the big data analysis unit 41 which can only perform analysis of user class with respect to the age class in which users are likely to come to the store for each store, and when a user outside of the target age class comes to the store, the server terminal device 40 is inquired. Alternatively, it is also possible to add a module having all functions of the server terminal device 40 to the edge terminal device 20 so as to omit the server terminal device 40. Conversely, a part of the function of the edge terminal device 20 may also be implemented in the server terminal device 40. For example, the function of the interest estimation unit 25 of the edge terminal device 20 may be implemented in the server terminal device 40.

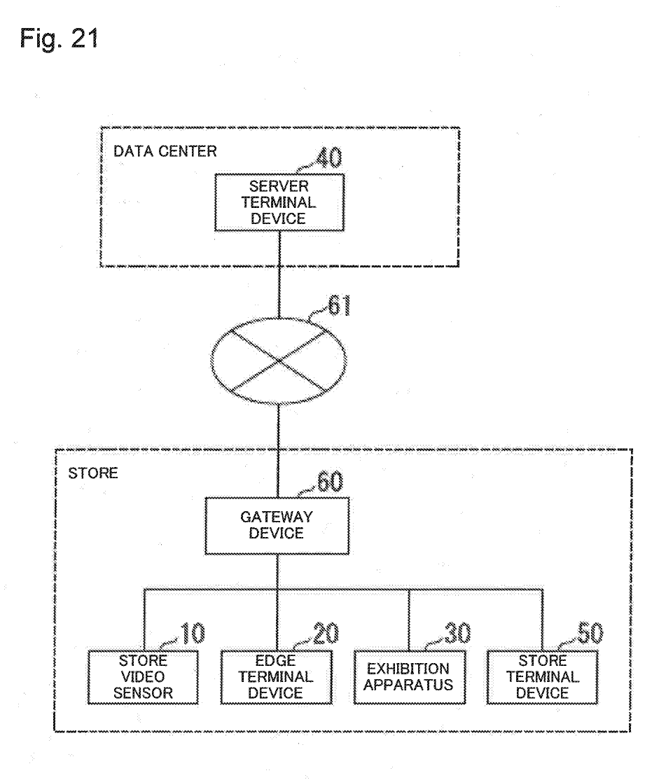

FIG. 22 is a network diagram showing the second network configuration applied to the exhibition system according to the present invention. In the second network configuration shown in FIG. 22, the function of the edge terminal device 20 is implemented in the server terminal device installed in the data center. Here, the store video sensor 10, the exhibition apparatus 30, and the store terminal device 50 are connected to the LAN on the store side. The LAN on the store side is connected to the network 61 such as the Internet and a carrier network via the gateway device 60. The server terminal device 40 is installed in the data center 6. A server terminal device 70 having the same function as the edge terminal device 20 is installed in the data center 7. The server terminal device 70 communicates with the server terminal device 40 installed in the data center 7 via the network 61. The exhibition apparatus 30 communicates with the server terminal device 70 installed in the data center 7 via the network 61. It should be noted that that the server terminal device 40 and the server terminal device 70 may be installed in the same data center 6. The second network configuration is applicable not only to the exhibition system 1 according to the first embodiment but also to the exhibition system 2, 3 according to the second embodiment and the third embodiment.

As explained with reference to FIG. 21 and FIG. 22, with respect to the exhibition systems 1 to 5 according to the first embodiment to the fifth embodiment, the function of the edge terminal device 20 may be installed in the server terminal device 70 on the data center side, and the edge terminal device 20 may not be provided on the store side. Further, the function of the server terminal device 40 may be installed in the edge terminal device 20, and the server terminal device 40 may not be provided. Alternatively, a configuration may be adopted in which the edge terminal device 20 and the server terminal device 40 are individually provided and the above-described functions are arbitrarily allocated to the edge terminal device 20 and the server terminal device 40.

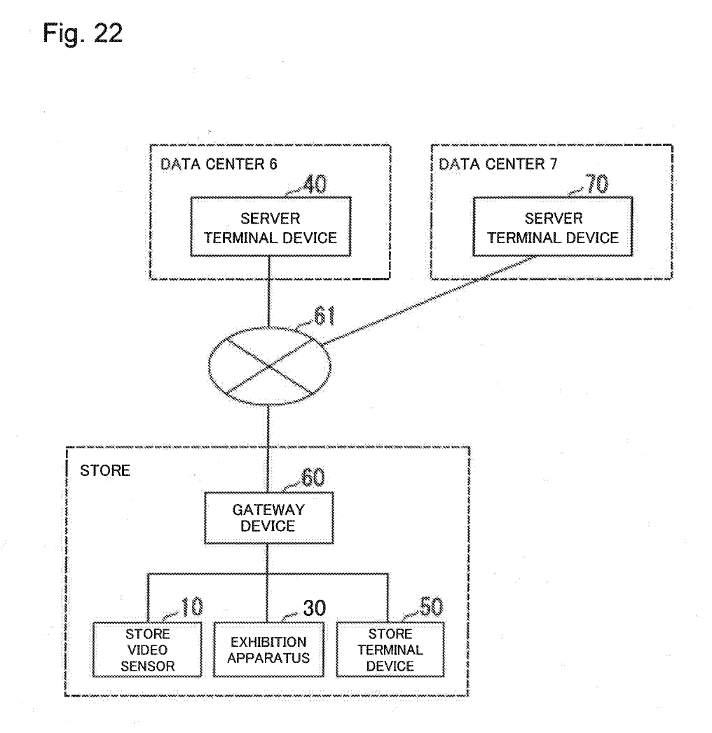

FIG. 23 is a block diagram showing the minimum configuration of an exhibition system 8 according to the present invention. The exhibition system 8 includes an exhibition apparatus 30 and a control device 20a. The exhibition apparatus 30 has at least an exhibition area 31 and a display area 320. In the exhibition area 31, the actual product (real object) is exhibited. The exhibition area 31 is, for example, a shelf exhibiting the products, and a stand or a net hanging and showing the products. The display area 320 is one area of an image displayed on an output unit such as, for example, a display, in association with the real object exhibited in the exhibition area 31. The control device 20a includes at least a control unit 250a. The exhibition apparatus 30 and the control device 20a are communicatively connected. The control unit 250a of the control device 20a controls the exhibition apparatus 30.

The control unit 250a has a function of determining whether or not to change the display area 320 based on at least one of real object information and moving object information. In addition, the control unit 250a may have a function of changing the display mode of the display area 320 based on at least one of the real object information and the moving object information. It should be noted that the above edge terminal devices 20, 201, 202, and 203 exemplify the control device 20a, and the output instruction units 26, 260, 261, and 262 exemplify the control unit 250a.

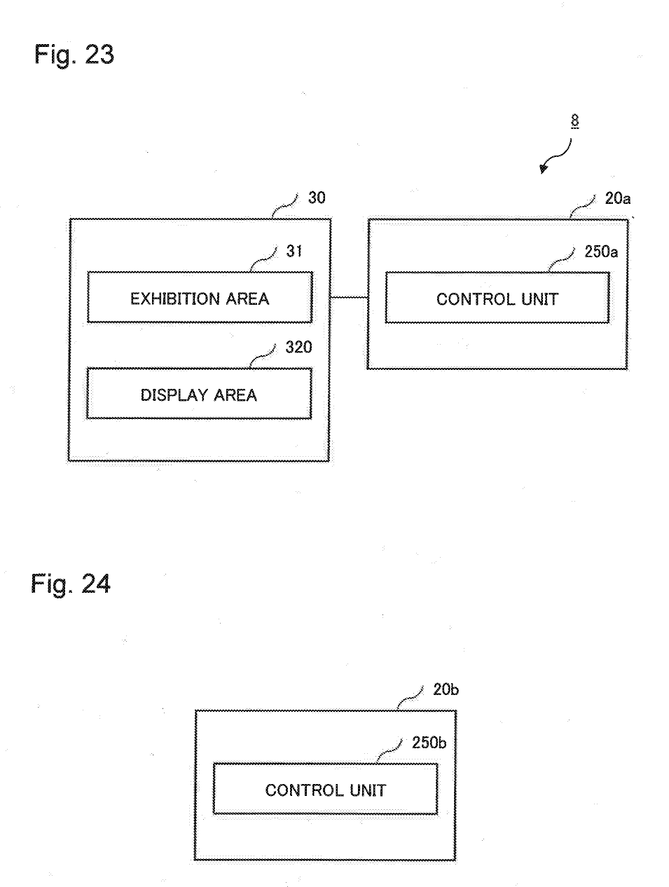

FIG. 24 is a block diagram showing the minimum configuration of the control device 20b included in the exhibition system according to the present invention. The control device 20b has at least a control unit 250b. The control unit 250b controls an exhibition apparatus (not shown) having an exhibition area showing an actual product (real object) and a display area corresponding to the real object. For example, the control unit 250b changes the display mode of the display area based on at least one of real object information and moving object information. It should be noted that the edge terminal device 204 exemplifies the control device 20b and the output control unit 263 exemplifies the control unit 250b.

In the first embodiment to the fifth embodiment of the present invention, the situation where the product is volume-displayed with the exhibition apparatus installed in the store has been explained, but the exhibition system according to the present invention can be used in other situations as follows.

### FIRST EXAMPLE

At the store, a security guard poster is exhibited on the exhibition area of the exhibition apparatus 30. For example, in the case of the first embodiment, a face photograph of a person who is likely to have shoplifted in the past is registered in advance, and when that person visits the store, the display area corresponding to the security guard poster is volume-displayed. Alternatively, in the case of the third embodiment, when an operation is detected in which the customer picks up the product and puts the product into the bag directly in front of the shelf, the display area corresponding to the security guard poster is volume-displayed. As a result, shoplifting prevention effect can be expected.

### SECOND EXAMPLE

In a situation where a store or AI (Artificial Intelligence) robot automatically collects products specified by customers, operators, and the like, the display area corresponding to the product that is to be collected and that is exhibited in the exhibition area of the exhibition apparatus 30 is volume-displayed. For example, in the case of the second embodiment, the product may be volume-displayed according to the distance between the AI robot and the exhibition apparatus 30. Alternatively, a product that is a collection target may be volume-displayed. Thus, it can be expected that the recognition accuracy of the collection target product by the AI robot is improved.

### THIRD EXAMPLE

In an exhibition site, the display area corresponding to the product (exhibit) exhibited in the exhibition area of the exhibition apparatus 30 may be volume-displayed, as explained in the first embodiment to the fifth embodiment. This makes it possible to appeal the exhibits according to the interest of the people who are present at the exhibition site.

### FOURTH EXAMPLE

The exhibition apparatus 30 may be installed on the farm to present a strawman in the exhibition area. Then, wild animals such as wild boars are detected with an image sensor and the display area corresponding to strawman is volume-displayed according to the distance between the wild animals and the exhibition apparatus 30 as in the second embodiment. For example, when the boar comes closer to the exhibition apparatus 30, the image of strawman is enlarged and displayed, or a lot of strawman are displayed. This can be expected to prevent wild animals such as wild boars from damaging the farm.

### FIFTH EXAMPLE

The exhibition apparatus 30 is placed in the aisle inside and outside of the building and a sign is exhibited to guide the exit, destination, and the like to the exhibition area. Then, when an approach of a person is detected with a person detection sensor or the like, the display area corresponding to the sign is volume-displayed to guide the person. Accordingly, it can be expected that this can prevent a person who passes complicated underground road with few marks from getting lost.

### SIXTH EXAMPLE

The exhibition apparatus 30 is placed near the road where traffic accidents occur frequently, and traffic signs and an exhibition posters and the like calling for attention is exhibited in the exhibition area. When the vehicle approaches within a predetermined distance with respect to the exhibition apparatus 30, the display area corresponding to traffic signs or the like is volume-displayed. This can be expected to prevent the occurrence of traffic accidents.

### SEVENTH EXAMPLE

AI robots for transporting chemicals and specimens have been introduced in hospitals. In this case, the exhibition apparatus 30 is placed in the hospital and the mark sign is exhibited in the exhibition area. Then, when it is detected that the AI robot exists within a predetermined distance from the exhibition apparatus 30, the exhibition apparatus 30 displays the mark sign in volume-display. As a result, the recognition accuracy of the AI robot improves, and chemicals and the like can be reliably delivered to the destination. In the application example described above, the moving object may be any of a person (user, store clerk, and the like), animals, objects (robots, unmanned aerial vehicles, and the like).

In the above embodiment, the edge terminal device 20 is described as a personal computer (PC) or the like, but all the functions or some functions of the edge terminal device 20 and all functions or some functions of the store video sensor 10 and the edge terminal device 20 may be provided in the robot. In other words, in the exhibition system according to the present invention, a robot can be provided instead of the edge terminal device 20. Alternatively, both of the edge terminal device 20 and the robot may be included in the exhibition system according to the present invention.

The above exhibition apparatus 30 has a computer system provided therein. The above-described processing of the exhibition apparatus 30 is stored in a computer-readable medium in a program format, and the above-described processing is performed by causing the computer to read and execute the program. Here, the computer-readable recording medium is a magnetic disk, a magneto-optical disk, a CD-ROM, a DVD-ROM, a semiconductor memory, or the like. A computer program implementing the function of the present invention may be delivered to the computer via a communication line so that the computer executes the computer program. The program described above may be for realizing a part of the function of the present invention. Further, the above-described program may be a so-called difference program (difference file) that can realize the function of the present invention in combination with a program already recorded in the computer system.

Finally, the present invention is not limited to the above-described embodiments and modifications but the present invention also includes design changes and modifications within the scope of the invention as defined in the appended claims. For example, the edge terminal devices 20, 201, 202 and the server terminal device 70 exemplify an information processing device which cooperates with the exhibition apparatus in the exhibition system.

### INDUSTRIAL APPLICABILITY

The present invention is applied to an exhibition apparatus, a display control apparatus, and an exhibition system which are installed in a store and the like to exhibit a product and display an image and product explanation about the product, but the present invention is not limited thereto. The present invention can be widely applied to facilities such as warehouses and hospitals and social life infrastructures such as roads and public facilities.

### REFERENCE SIGNS LIST

1, 2, 3, 4, 5 exhibition system
6, 7 data center
10 store video sensor
11 two dimensional camera
12 three dimensional camera
20, 201, 202, 203, 204 edge terminal device
21 video input unit
22 meta-data conversion unit
23 meta-data transmission unit
24 market data reception unit
25 interest estimation unit
26, 260, 261, 262 output instruction unit
27 input information reception unit
28 data output unit
29 storage unit
30, 300, 301 exhibition apparatus
302 control device
31 exhibition area
32 output unit
320 display area
33, 330, 331 control unit
34 communication unit
35 input accepting unit
36 storage unit
40 server terminal device
41 big data analysis unit
50 store terminal device
51 PC
52 smart device
60 gateway device
61 network
70 server terminal device
100, 101 floor
110, 111 cash register
120, 121 cash register shelf
130, 131 shelf

What is claimed is:

1. An exhibition apparatus comprising:
an exhibition area exhibiting a real object;
a display area corresponding to the real object; and
a control unit which changes a display mode of the display area based on at least one of real object information about the real object and moving object information about a moving object.

2. The exhibition apparatus according to claim 1, wherein the real object information is information about an actual product, and the moving object information is information about a user.

3. The exhibition apparatus according to claim 1 wherein the control unit determines whether to change a display mode of the display area based on at least one of the real object information and the moving object information.

4. The exhibition apparatus according to claim 1, wherein the control unit controls a display mode of the display area based on time and date information and visit tendency information about the moving object.

5. The exhibition apparatus according to claim 1, wherein the control unit controls a display mode of the display area based on past purchase behavior history of the moving object.

6. The exhibition apparatus according to claim 1, wherein the control unit controls a display mode of the display area in accordance with an attribute of the moving object.

7. The exhibition apparatus according to claim 1, wherein the control unit controls a display mode of the display area according to behavior in which the moving object selects the real object.

8. The exhibition apparatus according to claim 1, wherein the control unit controls a display mode of the display area according to a distance between the moving object and the exhibition apparatus.

9. The exhibition apparatus according to claim 1, wherein the control unit controls a display mode of the display area according to an attribute of the real object.

10. The exhibition apparatus according to claim 1, wherein the control unit enlarges the display area based on at least one of the real object information and the moving object information.

11. The exhibition apparatus according to claim 1, wherein the control unit enlarges the display area based on at least one of the real object information and the moving object information, and changes at least one of a number of the real objects or a size of the real object to display in the enlarged display area, and a color or brightness of the enlarged display area.

12. The exhibition apparatus according to claim 1, wherein a plurality of exhibition areas are provided according to a number or type of the real object, and
a plurality of display areas are provided in association with the plurality of exhibition areas.

13-15. (canceled)

16. An exhibition system comprising an exhibition apparatus and an information processing device, wherein the exhibition apparatus includes an exhibition area exhibiting a real object, a display area corresponding to the real object, and a control unit which changes a display mode of the display area based on at least one of real object information about the real object and moving object information about a moving object,
the information processing device includes an interest estimation unit estimating whether the moving object is interested in the real object exhibited in the exhibition area, and
the control unit changes a display mode of the display area corresponding to an image of the real object which the interest estimation unit estimates that the moving object is interested in.

17. The exhibition system according to claim 16, wherein the control unit controls a display mode of the display area based on time and date information and visit tendency information about the moving object.

18. The exhibition system according to claim 16, wherein the control unit controls a display mode of the display area based on past purchase behavior history of the moving object or an attribute of the moving object.

19. A display control method to be applied to an exhibition apparatus including an exhibition area and a display area, comprising:
displaying, in the display area, an image corresponding to a real object exhibited in the exhibition area; and
changing a display mode of the display area based on at least one of real object information about the real object and moving object information about a moving object.

20. (canceled)
